(19) United States
(12) Patent Application Publication
(10) Pub. No.: US 2023/0387505 A1
(43) Pub. Date: Nov. 30, 2023

(54) VEHICLE AND HEAT EXCHANGE PLATE

(71) Applicant: Panasonic Intellectual Property Management Co., Ltd., Osaka (JP)

(72) Inventors: Katsuji TANIGUCHI, Kanagawa (JP); Atsushi SUEYOSHI, Tokyo (JP); Yoshitoshi NODA, Kanagawa (JP); Yuki MAKITA, Kanagawa (JP)

(73) Assignee: Panasonic Intellectual Property Management Co., Ltd., Osaka (JP)

(21) Appl. No.: 18/233,001

(22) Filed: Aug. 11, 2023

Related U.S. Application Data
(63) Continuation of application No. PCT/JP2021/045883, filed on Dec. 13, 2021.

(30) Foreign Application Priority Data
Feb. 19, 2021 (JP) 2021-025622
Mar. 10, 2021 (JP) 2021-038370
Mar. 10, 2021 (JP) 2021-038371

(51) Int. Cl. H01M 10/6556; H01M 10/625; H01M 10/6568; H01M 10/647; H01M 10/613

(52) U.S. Cl. CPC H01M 10/6556; H01M 10/625; H01M 10/6568; H01M 10/647; H01M 10/613

(57) ABSTRACT

A heat exchange plate includes a coolant layer, a refrigerant layer, a first end portion, and a second end portion opposite to the first end portion. The refrigerant layer includes a refrigerant input portion disposed at the first end portion, a refrigerant output portion disposed at the first end portion, a first refrigerant flow path connected to the refrigerant input portion, a second refrigerant flow path connected to the refrigerant output portion, and a connection portion connecting the first and second refrigerant flow paths. The first refrigerant flow path includes a first branch portion, a first converging portion, and a plurality of first branch flow paths connecting the first branch portion and the first converging portion, and the second refrigerant flow path includes a second branch portion, a second converging portion, and a plurality of second branch flow paths connecting the second branch portion and the second converging portion.

### CROSS-REFERENCE TO RELATED APPLICATIONS

This is a continuation of International Application No. PCT/JP2021/045883 filed on Dec. 13, 2021, and claims priority from Japanese Patent Application No. 2021-025622 filed on Feb. 19, 2021, Japanese Patent Application No. 2021-038370 filed on Mar. 10, 2021, and Japanese Patent Application No. 2021-038371 filed on Mar. 10, 2021, the entire content of which is incorporated herein by reference.

### TECHNICAL FIELD

The present disclosure relates to a vehicle and a heat exchange plate.

### BACKGROUND ART

An in-vehicle battery that supplies electric power to a motor, which is a drive source, is mounted on a hybrid vehicle and an electric vehicle. The vehicle is provided with a heat exchange plate that reduces an increase in temperature of the in-vehicle battery. A flow path through which a refrigerant flows is provided in the heat exchange plate (Patent Literatures 1 and 2).

### CITATION LIST

### Patent Literature

Patent Literature 1: JP6284543B
Patent Literature 2: JP6494134B
Patent Literature 3: CN107112612A
Patent Literature 4: JP2008-44476A
Patent Literature 5: JP6098121B
Patent Literature 6: JP2010-50000A

### SUMMARY OF INVENTION

In order to uniformly reduce the increase in temperature of the in-vehicle battery as much as possible by the heat exchange plate, it is preferable that the refrigerant flows uniformly as much as possible in the entire flow path. However, it is difficult to cause the refrigerant to flow uniformly through the entire flow path due to a pressure loss or the like of the refrigerant flowing through the flow path.

An object of the present disclosure is to provide a technique for allowing a refrigerant to flow more uniformly through a flow path of a heat exchange plate.

According to a present disclosure, a heat exchange plate installable on a vehicle movable in a predetermined direction using a first wheel and a second wheel is provided. The vehicle includes a vehicle body, the first wheel and the second wheel coupled to the vehicle body, a battery cell group disposed along a predetermined plane in the vehicle body and including a plurality of battery cells, a heat exchange plate disposed along the predetermined plane in the vehicle body, an electric motor configured to drive at least the first wheel using electric power supplied from the battery cell group, and a refrigerant circuit including at least a compressor and a condenser. The heat exchange plate includes a first surface disposed along the predetermined plane; a second surface opposite to the first surface; a coolant layer configured to allow a coolant to circulate between the first surface and the second surface; a refrigerant layer configured to allow a refrigerant to circulate between the first surface and the second surface; a first end portion in the predetermined direction; and a second end portion opposite to the first end portion in the predetermined direction. The refrigerant layer includes a refrigerant input portion disposed at the first end portion and configured to enter the refrigerant layer from the refrigerant circuit, a refrigerant output portion disposed at the first end portion and configured to exit from the refrigerant layer to the refrigerant circuit, a first refrigerant flow path connected to the refrigerant input portion and disposed along the predetermined direction, a second refrigerant flow path connected to the refrigerant output portion and disposed along the predetermined direction, and a connection portion connecting the first refrigerant flow path and the second refrigerant flow path. The first refrigerant flow path includes a first branch portion, a first converging portion, and a plurality of first branch flow paths connecting the first branch portion and the first converging portion. The second refrigerant flow path includes a second branch portion, a second converging portion, and a plurality of second branch flow paths connecting the second branch portion and the second converging portion. The refrigerant is movable through the refrigerant input portion, the first branch portion, the first branch flow paths, the first converging portion, the connection portion, the second branch portion, the second branch flow paths, the second converging portion, and the refrigerant output portion in this order, and the connection portion is disposed closer to the second end portion than a midpoint of the refrigerant layer in the predetermined direction.

Further, according to a present disclosure, a vehicle movable in a predetermined direction using a first wheel and a second wheel is provided. The vehicle includes a vehicle body; the first wheel and the second wheel coupled to the vehicle body; a battery cell group disposed along a predetermined plane in the vehicle body and including a plurality of battery cells; a heat exchange plate disposed along the predetermined plane in the vehicle body; an electric motor configured to drive at least the first wheel using electric power supplied from the battery cell group; and a refrigerant circuit including at least a compressor and a condenser. The heat exchange plate includes a first surface disposed along the predetermined plane, a second surface opposite to the first surface, a coolant layer configured to allow a coolant to circulate between the first surface and the second surface, a refrigerant layer configured to allow a refrigerant to circulate between the first surface and the second surface, a first end portion in the predetermined direction, and a second end portion opposite to the first end portion in the predetermined direction. The refrigerant layer includes a refrigerant input portion disposed at the first end portion and configured to allow the refrigerant to enter the refrigerant layer from the refrigerant circuit, a refrigerant output portion disposed at the first end portion and configured to allow the refrigerant to exit from the refrigerant layer to the refrigerant circuit, a first refrigerant flow path connected to the refrigerant input portion and disposed along the predetermined direction, a second refrigerant flow path connected to the refrigerant output portion and disposed along the predetermined direction, and a connection portion connecting the first refrigerant flow path and the second refrigerant flow path. The first refrigerant flow path includes a first branch portion, a first converging portion, and a plurality of first branch flow paths connecting the first branch portion and the first converging portion. The second refrigerant flow path includes a second branch portion, a second converging portion, and a plurality of second branch flow paths connecting the second branch portion and the second converging portion. The refrigerant is movable through the refrigerant input portion, the first branch portion, the first branch flow paths, the first converging portion, the connection portion, the second branch portion, the second branch flow paths, the second converging portion, and the refrigerant output portion in this order, and the connection portion is disposed closer to the second end portion than a midpoint of the refrigerant layer in the predetermined direction.

According to the present disclosure, it is possible to cause a refrigerant to flow more uniformly through an entire flow path of a heat exchange plate.

### BRIEF DESCRIPTION OF DRAWINGS

FIG. 1A is a plan view showing a configuration example of a vehicle according to a first embodiment;

FIG. 1B is a left side view showing the configuration example of the vehicle according to the first embodiment;

FIG. 2 is a diagram showing an example of an electric circuit provided in the vehicle according to the first embodiment;

FIG. 3A is a perspective view showing a configuration example of a battery pack according to the first embodiment;

FIG. 3B is a cross-sectional view taken along a line A-A of the battery pack shown in FIG. 3A;

FIG. 3C is a cross-sectional view taken along a line B-B of the battery pack shown in FIG. 3A;

FIG. 4 is a plan view showing a configuration example of a heat exchange plate according to the first embodiment;

FIG. 5A is a perspective view showing a first configuration example of the heat exchange plate according to the first embodiment;

FIG. 5B is a perspective view of a cross section taken along a line A-A of the heat exchange plate shown in FIG. 5A;

FIG. 6A is a perspective view showing a second configuration example of the heat exchange plate according to the first embodiment;

FIG. 6B is a perspective view of a cross section taken along a line A-A of the heat exchange plate shown in FIG. 6A;

FIG. 7 is a cross-sectional perspective view showing a configuration of a heat exchange plate for comparison;

FIG. 8 shows schematic views illustrating modifications of the heat exchange plate according to the first embodiment;

FIG. 9 is a schematic view showing a configuration example of a battery cooling system including a heat exchange plate according to a second embodiment and a refrigerant circuit and a coolant circuit which are connected to the heat exchange plate;

FIG. 10 is a plan view showing a configuration example of the heat exchange plate according to the second embodiment;

FIG. 11 is a plan view showing a configuration example of a coolant flow path in the heat exchange plate according to the second embodiment;

FIG. 12 is a plan view showing a configuration example of a refrigerant flow path in the heat exchange plate according to the second embodiment;

FIG. 13 is a plan view showing a configuration example of the vicinity of a refrigerant input portion and a refrigerant output portion in the refrigerant flow path according to the second embodiment;

FIG. 14 is a cross-sectional view showing a first example of a cross section taken along a line B-B in FIG. 13 according to the second embodiment;

FIG. 15 is a cross-sectional view showing a second example of the cross section taken along the line B-B in FIG. 13 according to the second embodiment;

FIG. 16 is an example of a p-h diagram relating to a refrigerant flowing through the refrigerant circuit and the refrigerant flow path shown in FIGS. 9 and 10 according to the second embodiment;

FIG. 17 is a plan view showing a first modification of a configuration of the heat exchange plate according to the second embodiment;

FIG. 18 is a plan view showing a second modification of the configuration of the heat exchange plate according to the second embodiment;

FIG. 19 is a plan view showing a third modification of the configuration of the heat exchange plate according to the second embodiment;

FIG. 20 is a plan view showing a fourth modification of the configuration of the heat exchange plate according to the second embodiment;

FIG. 21 is a plan view showing a fifth modification of the configuration of the heat exchange plate according to the second embodiment;

FIG. 22 is an example of a p-h diagram relating to the refrigerant flowing through the refrigerant circuit according to the second embodiment and a refrigerant flow path shown in FIG. 21;

FIG. 23 is a plan view showing a first configuration example of a refrigerant layer of a heat exchange plate according to a third embodiment;

FIG. 24A is a plan view showing a configuration example of a coolant layer of the heat exchange plate according to the third embodiment;

FIG. 24B is a plan view showing a configuration example of the coolant layer of the heat exchange plate according to the third embodiment;

FIG. 25 is a plan view showing a second configuration example of the refrigerant layer of the heat exchange plate according to the third embodiment;

FIG. 26 is a plan view showing a third configuration example of the refrigerant layer of the heat exchange plate according to the third embodiment;

FIG. 27 is a plan view showing a fourth configuration example of the refrigerant layer of the heat exchange plate according to the third embodiment;

FIG. 28 is a plan view showing a fifth configuration example of the refrigerant layer of the heat exchange plate according to the third embodiment;

FIG. 29 is a plan view showing a sixth configuration example of the refrigerant layer of the heat exchange plate according to the third embodiment.

FIG. 30 is a plan view showing a seventh configuration example of the refrigerant layer of the heat exchange plate according to the third embodiment;

FIG. 31 is a plan view showing an eighth configuration example of the refrigerant layer of the heat exchange plate according to the third embodiment;

FIG. 32A is a perspective view showing a ninth configuration example of the refrigerant layer of the heat exchange plate according to the third embodiment; and

FIG. 32B is a plan view showing the ninth configuration example of the refrigerant layer of the heat exchange plate according to the third embodiment.

### DESCRIPTION OF EMBODIMENTS

Hereinafter, embodiments of the present disclosure will be described in detail with reference to the drawings as appropriate. However, the unnecessarily detailed description may be omitted. For example, the detailed description of already well-known matters and the repeated description of substantially the same configuration may be omitted. This is to avoid the following description from being unnecessarily redundant and facilitate understanding by those skilled in the art. The accompanying drawings and the following description are provided for those skilled in the art to fully understand the present disclosure, and are not intended to limit the subject matter described in the claims.

### First Embodiment

### <Configuration of Vehicle>

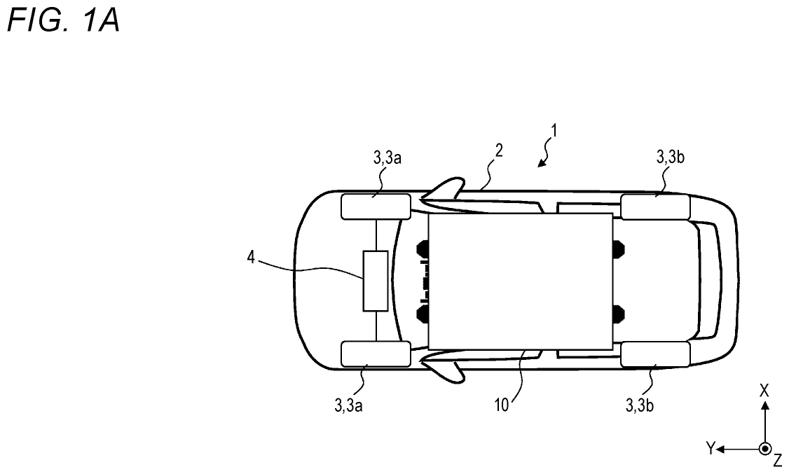

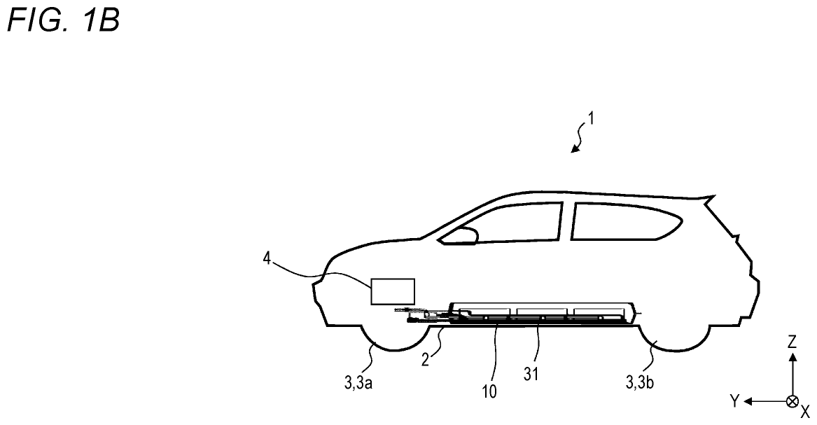

FIG. 1A is a plan view showing a configuration example of a vehicle 1 according to a first embodiment. FIG. 1B is a left side view showing the configuration example of the vehicle 1 according to the first embodiment.

For convenience of description, as shown in FIG. 1, an axis extending in a height direction of the vehicle 1 is taken as a Z axis. An axis perpendicular to the Z axis (that is, parallel to ground) and extending in a traveling direction of the vehicle 1 is taken as a Y axis. An axis perpendicular to the Y axis and the Z axis (that is, an axis in a width direction of the vehicle 1) is taken as an X axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. These expressions are the same for other drawings describing the XYZ axes. Expressions related to these directions are used for convenience of description, and are not intended to limit a posture during actual use of this structure.

The vehicle 1 includes a vehicle body 2, wheels 3, an electric motor 4, and a battery pack 10.

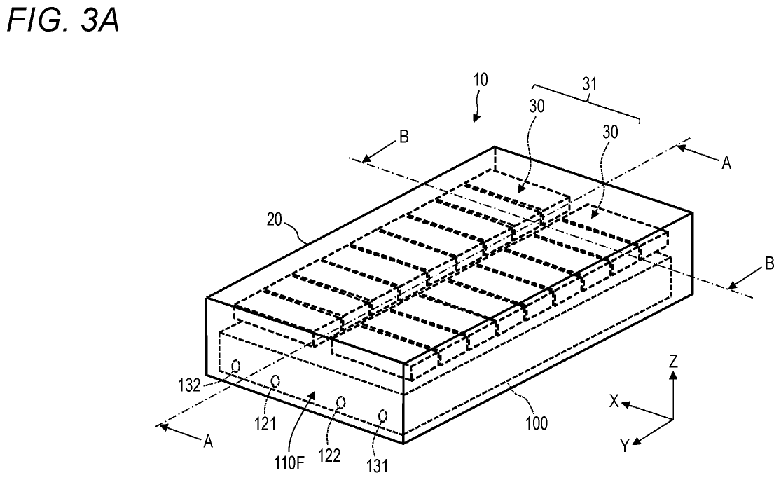

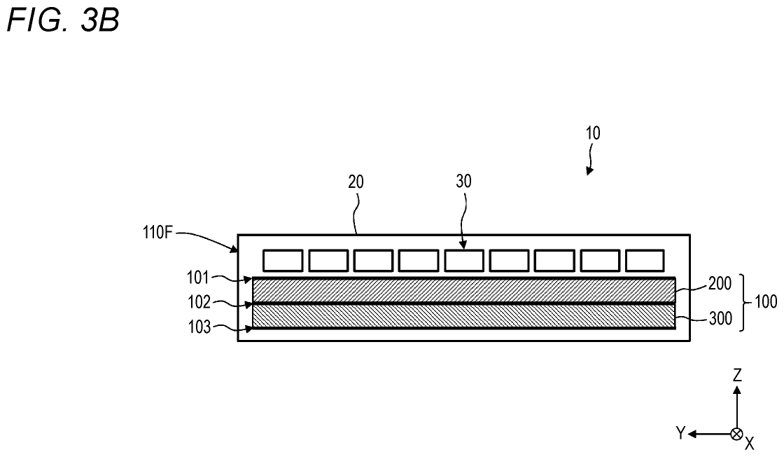

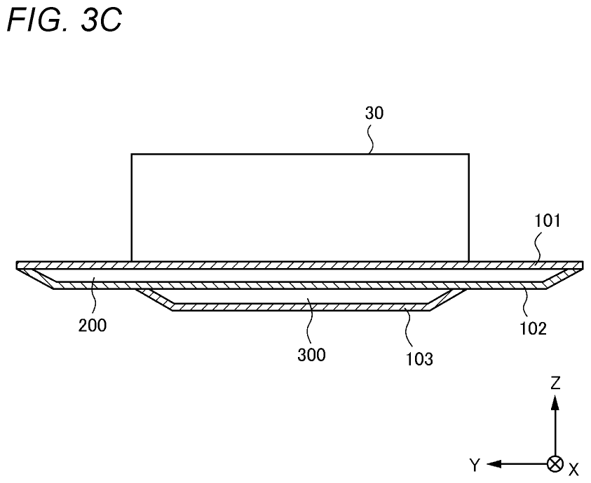

The battery pack 10 is accommodated in the vehicle body 2. The battery pack 10 includes a plurality of battery modules 30 (see FIG. 3A) capable of being charged and discharged. Hereinafter, the plurality of battery modules 30 provided in the battery pack 10 will be referred to as a battery module group 31. An example of the battery module 30 is a lithium ion battery. The battery module group 31 supplies (discharges) stored electric power to the electric motor 4 or the like. The battery module group 31 may store (charge) electric power generated by the electric motor 4 by regenerative energy. As shown in FIG. 1, the battery pack 10 may be accommodated under a floor of a center of the vehicle body 2. The battery pack 10 will be described in detail later.

The wheels 3 are coupled to the vehicle body 2. Although FIGS. 1A and 1B show an automobile in which the vehicle 1 includes four wheels 3, the vehicle 1 may include at least one wheel 3. For example, the vehicle 1 may be a motorcycle including two wheels 3 or a vehicle including three or five or more wheels 3. Further, one of the plurality of wheels 3 provided in the vehicle 1 may be referred to as a first wheel 3a, and one of the plurality of wheels 3, which is different from the first wheel 3a, may be referred to as a second wheel 3b. The first wheel 3a may be a front wheel of the vehicle 1, and the second wheel 3b may be a rear wheel of the vehicle 1. The vehicle 1 is movable in a predetermined direction (for example, a front-rear direction) by the first wheel 3a and the second wheel 3b.

The electric motor 4 drives at least one wheel 3 (for example, the first wheel 3a) using the electric power supplied from the battery module group 31. The vehicle 1 includes at least one electric motor 4. The vehicle 1 may have a configuration in which the electric motor 4 drives a front wheel (that is, a front wheel drive configuration). Alternatively, the vehicle 1 may have a configuration in which the electric motor 4 drives the rear wheel (that is, a rear wheel drive configuration) or a configuration in which the electric motor 4 drives both the front wheel and the rear wheel (that is, a four wheel drive configuration). Alternatively, the vehicle 1 may include a plurality of electric motors 4, and each of the plurality of electric motors 4 may individually drive the wheel 3. The electric motor 4 may be installed in a motor room (engine room) located in front of the vehicle 1.

<Configuration of Electric Circuit>

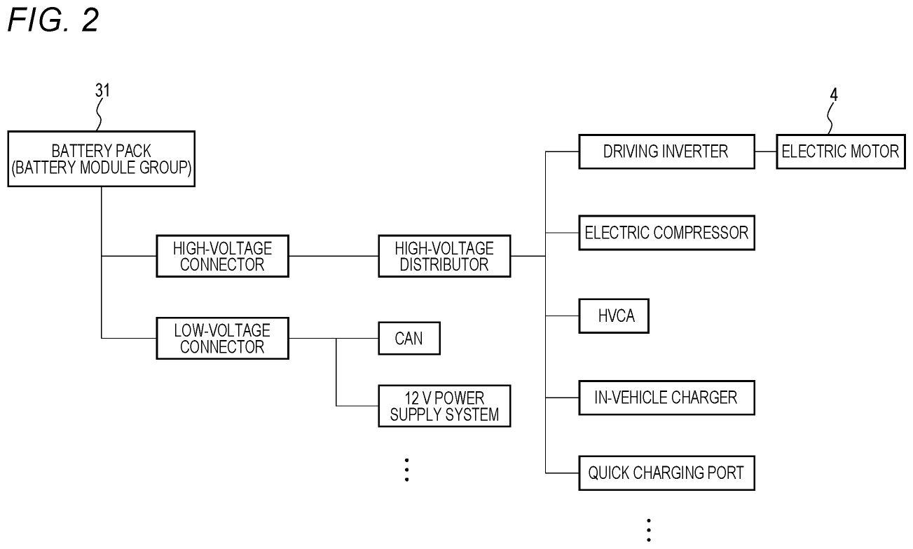

FIG. 2 is a diagram showing an example of an electric circuit provided in the vehicle 1 according to the first embodiment.

The battery pack 10 including the battery module group 31 includes a high-voltage connector and a low-voltage connector. In the present disclosure, the high-voltage connector and the low-voltage connector are referred to as electrical connectors without being distinguished from each other.

A high-voltage distributor may be connected to the high-voltage connector. A driving inverter, a compressor, a heating, ventilation, and air conditioning (HVAC), an in-vehicle charger, and a quick charging port may be connected to the high-voltage distributor. A controller area network (CAN) and a 12 V power supply system may be connected to the low-voltage connector.

The electric motor 4 may be connected to the driving inverter. That is, the electric power output from the battery module group 31 may be supplied to the electric motor 4 through the high-voltage connector, the high-voltage distributor, and the driving inverter.

<Configuration of Battery Pack>

FIG. 3A is a perspective view illustrating a configuration example of the battery pack 10 according to the first embodiment. FIG. 3B is a cross-sectional view taken along a line A-A of the battery pack 10 shown in FIG. 3A. FIG. 3C is a cross-sectional view taken along a line B-B of the battery pack shown in FIG. 3A.

The battery pack 10 includes a housing 20, the battery module group 31, and a heat exchange plate 100. The housing 20 accommodates the battery module group 31 and the heat exchange plate 100.

The heat exchange plate 100 has, for example, a flat and substantially rectangular parallelepiped shape. The heat exchange plate 100 may be replaced with a heat exchanger. As shown in FIGS. 3B and 3C, the heat exchange plate 100 includes a first planar member 101 disposed along a predetermined plane, a second planar member 102 disposed along a predetermined plane, and a third planar member 103 disposed along a predetermined plane. The predetermined plane may be a floor of the vehicle body 2. The first planar member 101, the second planar member 102, and the third planar member 103 may be made of metal, for example, aluminum. However, the first planar member 101, the second planar member 102, and the third planar member 103 are not limited to the metal and may be other materials.

At least a part of the second planar member 102 is disposed between the first planar member 101 and the third planar member 103. The battery module group 31 is disposed at a position opposite to the second planar member 102 with reference to the first planar member 101. That is, the third planar member 103, the second planar member 102, and the first planar member 101 are arranged in this order from the floor of the vehicle body 2.

The heat exchange plate 100 includes a coolant layer 200 that allows a coolant to circulate between the first planar member 101 and the second planar member 102, and a refrigerant layer 300 that allows a refrigerant to circulate between the second planar member 102 and the third planar member 103. The heat exchange plate 100 exchanges heat between at least the battery module group 31 and the coolant via the first planar member 101. Further, the heat exchange plate 100 exchanges heat between at least the coolant in the coolant layer 200 and the refrigerant in the refrigerant layer 300 via the second planar member 102. Examples of the coolant include an antifreezing solution containing ethylene glycol. An example of the refrigerant is a hydrofluorocarbon (HFC).

In the present embodiment, the heat exchange plate 100 is configured such that the coolant layer 200 is disposed on the refrigerant layer 300. However, the heat exchange plate 100 may be configured such that the refrigerant layer 300 is disposed on the coolant layer 200. The coolant layer 200 may be replaced with a coolant plate. The refrigerant layer 300 may be replaced with a refrigerant plate. Further, details of the configuration of the heat exchange plate 100, and details of configurations of the coolant layer 200 and the refrigerant layer 300 will be described later.

The heat exchange plate 100 includes a coolant input portion 121, a coolant output portion 122, a refrigerant input portion 131, and a refrigerant output portion 132 on a front surface 110F that is a surface on a traveling direction side of the vehicle 1. The coolant input portion 121 is an inlet through which the coolant from an outside of the heat exchange plate 100 is input to the coolant layer 200. The coolant output portion 122 is an outlet through which the coolant is output from the coolant layer 200 to the outside of the heat exchange plate 100.

The refrigerant input portion 131 is an inlet through which the refrigerant is input from the outside of the heat exchange plate 100 to the refrigerant layer 300. The refrigerant output portion 132 is an outlet through which the refrigerant is output from the refrigerant layer 300 to the outside of the heat exchange plate 100.

<Details of Configuration of Heat Exchange Plate>

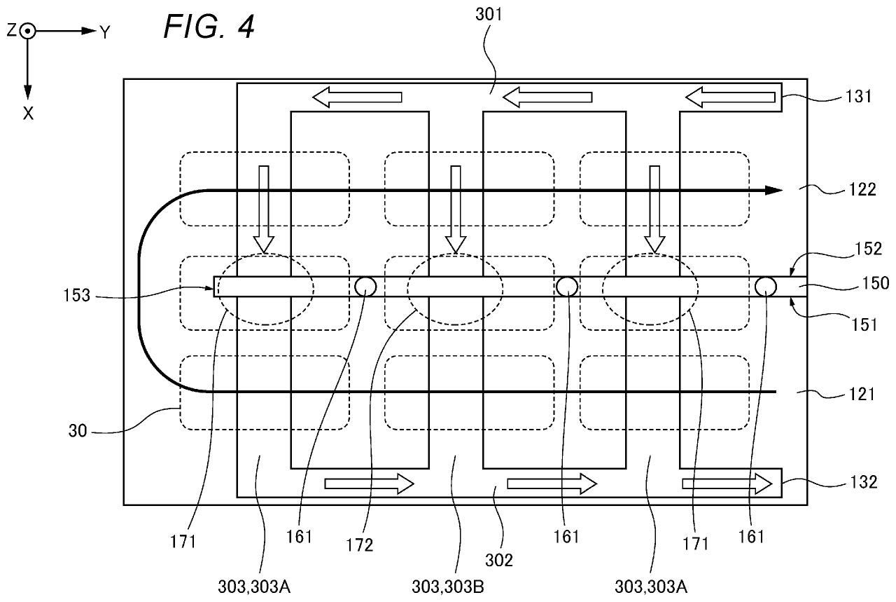

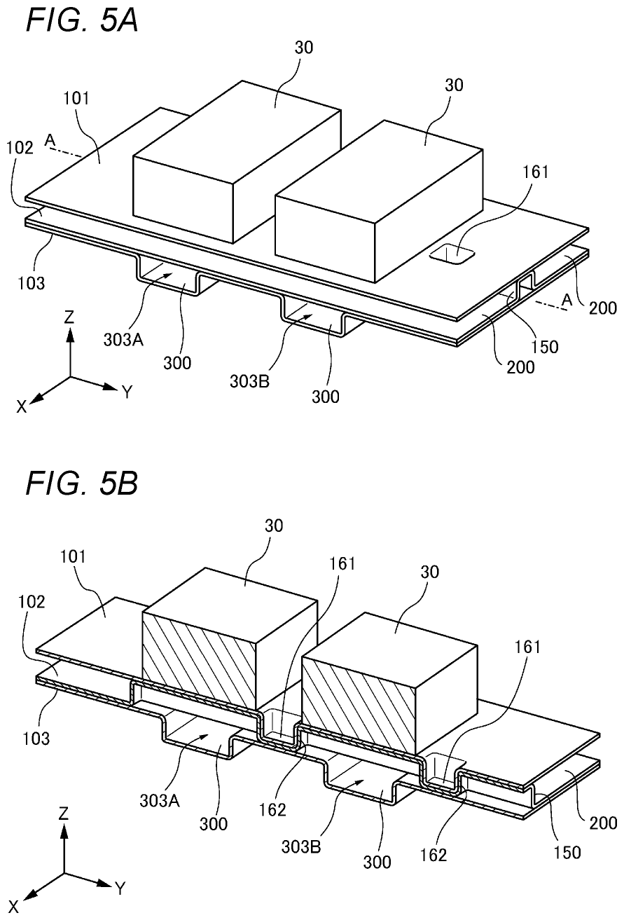

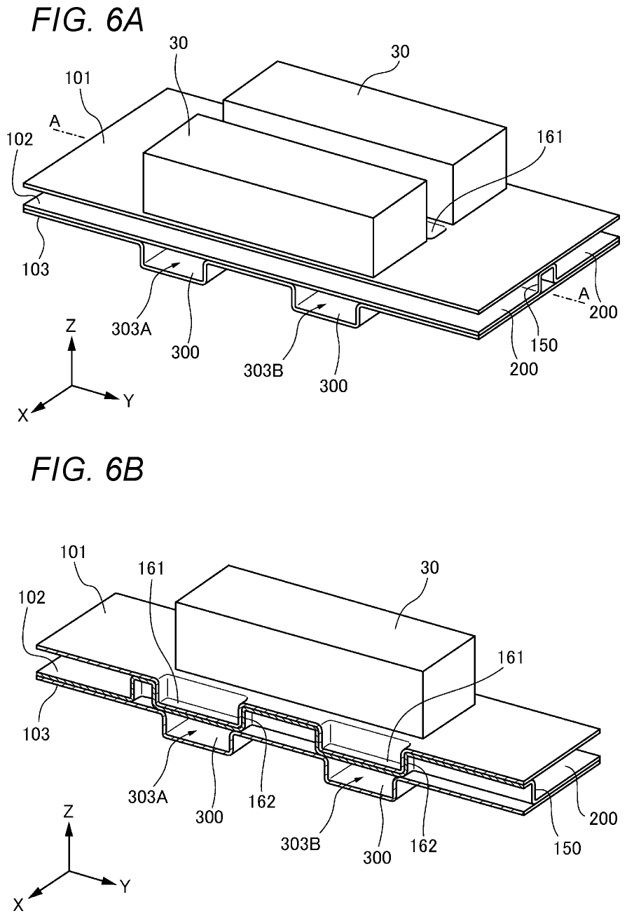

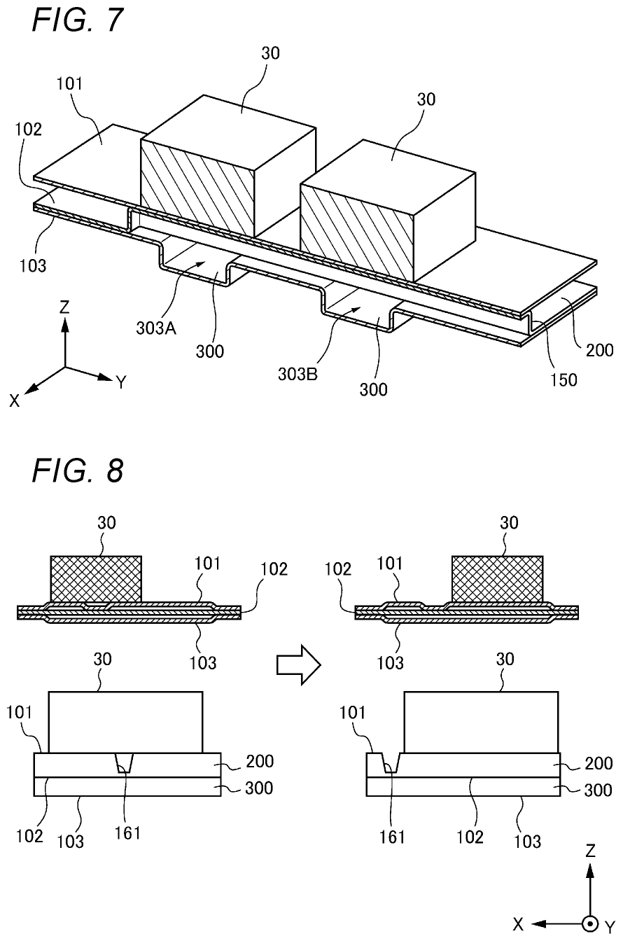

FIG. 4 is a plan view showing a configuration example of the heat exchange plate 100 according to the first embodiment. FIG. 5A is a perspective view showing a first configuration example of the heat exchange plate 100 according to the first embodiment. FIG. 5B is a perspective view of a cross section taken along a line A-A of the heat exchange plate 100 shown in FIG. 5A. FIG. 6A is a perspective view showing a second configuration example of the heat exchange plate 100 according to the first embodiment. FIG. 6B is a perspective view of a cross section taken along a line A-A of the heat exchange plate 100 shown in FIG. 6A. FIG. 7 is a cross-sectional perspective view showing a configuration of a heat exchange plate for comparison.

As shown in FIG. 4, the heat exchange plate 100 includes a wall portion 150 constituting at least a part of a flow path of the coolant in the coolant layer 200.

At least a part of the wall portion 150 of the coolant layer 200 may be disposed along a predetermined direction along a predetermined plane in the coolant layer 200. The predetermined plane may be the floor of the vehicle body 2. The predetermined direction of the wall portion 150 may be a direction (for example, a Y-axis direction) corresponding to the traveling direction in which the vehicle body can travel by the first wheel 3a and the second wheel 3b. However, the predetermined direction of the wall portion 150 is not limited to the traveling direction, and may be, for example, a direction orthogonal to the traveling direction (that is, a left-right direction when facing the traveling direction).

As shown in FIG. 4, the wall portion 150 may include a first wall surface 151, a second wall surface 152 opposite to the first wall surface 151, and an end surface 153 connecting the first wall surface 151 and the second wall surface 152. In the coolant layer 200, the coolant may flow from the coolant input portion 121, advance along the first wall surface 151, then advance along the end surface 153, then advance along the second wall surface 152, and may flow out from the coolant output portion 122.

As shown in FIGS. 5A, 5B, 6A, and 6B, at least a part of the wall portion 150 of the coolant layer 200 may include first protruding portions 161 protruding from the first planar member 101 toward the second planar member 102, and a second protruding portion 162 protruding from the second planar member 102 toward the first planar member 101. The first protruding portion 161 may be formed by pressing the first planar member 101. The second protruding portion 162 may be formed by pressing the second planar member 102. That is, the first protruding portion 161 and the second protruding portion 162 may be combined with each other to form at least a part of the wall portion 150 of the coolant layer 200. A position of the first protruding portion 161 will be described later.

A flow path of the refrigerant in the refrigerant layer 300 may be configured by a shape of the third planar member 103. The flow path of the refrigerant may be formed by pressing the third planar member 103.

For example, as shown in FIG. 4, the flow path of the refrigerant may include at least two refrigerant flow paths (hereinafter referred to as an input refrigerant flow path 301 and an output refrigerant flow path 302) extending in the same direction as the predetermined direction (for example, the Y-axis direction) of the wall portion 150, and a plurality of refrigerant flow paths (hereinafter referred to as branch refrigerant flow paths 303) connecting the input refrigerant flow path 301 and the output refrigerant flow path 302. The input refrigerant flow path 301 may be connected to the refrigerant input portion 131, and the output refrigerant flow path 302 may be connected to the refrigerant output portion 132. Hereinafter, two branch refrigerant flow paths 303 adjacent to each other may be referred to as a first refrigerant flow path 303A and a second refrigerant flow path 303B, respectively.

As shown in FIG. 4, at least a part of the wall portion 150 of the coolant layer 200 and at least a part of the first refrigerant flow path 303A may intersect at a first intersection 171 when viewed from a normal direction of the predetermined plane (for example, the floor of the vehicle body 2). At least a part of the wall portion 150 of the coolant layer 200 and at least a part of the second refrigerant flow path 303B may intersect at a second intersection 172 when viewed from the normal direction of the predetermined plane (for example, the floor of the vehicle body 2).

The first protruding portion 161 of the first planar member 101 may be disposed in a manner of corresponding to an intersection at which at least a part of the wall portion 150 of the coolant layer 200 and at least a part of the flow path of the refrigerant intersect with each other. For example, the first protruding portion 161 may be disposed between the first intersection 171 and the second intersection 172. In this case, the first protruding portion 161 may be disposed at a position that does not correspond to one of the plurality of battery modules 30.

Next, a problem that occurs when the first protruding portion 161 is not formed will be described with reference to FIG. 7, and an example of the wall portion 150 including the first protruding portion 161 and the second protruding portion 162 will be described with reference to FIGS. 5A, 5B, 6A, and 6B.

As shown in FIG. 7, when only the second planar member 102 is pressed to form the wall portion 150, the refrigerant flowing through the branch refrigerant flow path 303 (first refrigerant flow path 303A) flows into the adjacent branch refrigerant flow path 303 (second refrigerant flow path 303B) through an internal space of the wall portion 150. In this case, an intended cooling effect cannot be obtained in a design of the refrigerant flow path.

Therefore, as shown in FIGS. 5A and 5B, the first protruding portion 161 is formed on the first planar member 101 so as to form a part of the wall portion 150 of the coolant layer 200 between the first intersection 171 (see FIG. 4) at which the first refrigerant flow path 303A and the wall portion 150 of the coolant layer 200 intersect with each other and the second intersection 172 (see FIG. 4) at which the second refrigerant flow path 303B and the wall portion 150 of the coolant layer 200 intersect with each other. Further, when the second protruding portion 162 of the second planar member 102 is formed, a portion facing the first protruding portion 161 is not extruded. Accordingly, as shown in FIG. 5B, the second protruding portion 162 of the second planar member 102 and the first protruding portion 161 of the first planar member 101 are tightly fitted to form a part of the wall portion 150 of the coolant layer 200. In addition, the internal space of the wall portion 150 connected to the second refrigerant flow path 303B from the first refrigerant flow path 303A is divided by the first protruding portion 161 formed between the first intersection 171 and the second intersection 172. Accordingly, it is possible to prevent the refrigerant flowing through the first refrigerant flow path 303A from flowing into the second refrigerant flow path 303B through the internal space of the wall portion 150, or to prevent the refrigerant flowing through the second refrigerant flow path 303B from flowing into the first refrigerant flow path 303A through the internal space of the wall portion 150.

Alternatively, as shown in FIGS. 6A and 6B, the first protruding portion 161 may be formed on the first planar member 101 so as to form a part of the wall portion 150 of the coolant layer 200 at the first intersection 171 at which the first refrigerant flow path 303A and the wall portion 150 of the coolant intersect each other. For example, the first protruding portion 161 is formed on the first planar member 101 such that a width thereof is equal to or greater than a width of the first refrigerant flow path 303A at the first intersection 171 in the Y-axis direction. Further, when the second protruding portion 162 of the second planar member 102 is formed, a portion facing the first protruding portion 161 is not extruded. Accordingly, as shown in FIG. 6B, the second protruding portion 162 of the second planar member 102 and the first protruding portion 161 of the first planar member 101 are tightly fitted to form the wall portion 150 of the coolant layer 200. In addition, a portion connected to the internal space of the wall portion 150 from the first refrigerant flow path 303A at the first intersection 171 is blocked by the first protruding portion 161. Accordingly, it is possible to prevent the refrigerant flowing through the first refrigerant flow path 303A from flowing into the second refrigerant flow path 303B through the internal space of the wall portion 150, or to prevent the refrigerant flowing through the second refrigerant flow path 303B from flowing into the first refrigerant flow path 303A through the internal space of the wall portion 150. The second intersection point 172 and other intersection points may have the same configuration.

The first protruding portion 161 may be formed in a portion of the first planar member 101 where the battery module 30 is not disposed. This is because, when the first protruding portion 161 is formed in the portion of the first planar member 101 where the battery module 30 is disposed, an area of the first planar member 101 in contact with a bottom surface of the battery module 30 is reduced, and the cooling effect of the battery module 30 can be reduced.

<Modification>

FIG. 8 shows schematic views illustrating modifications of the heat exchange plate 100 according to the first embodiment.

As shown in FIG. 8, the second protruding portion 162 may not be formed on the second planar member 102, and the wall portion 150 of the coolant layer 200 may be configured by the first protruding portion 161 formed on the first planar member 101. In this case, an internal space of the wall portion 150 that connects the two adjacent branch refrigerant flow paths 303 as described above is not formed.

However, as shown in (a) of FIG. 8, when the battery module 30 is disposed above the first protruding portion 161 of the first planar member 101, the area of the first planar member 101 in contact with the bottom surface of the battery module 30 is reduced as described above, and the cooling effect of the battery module 30 can be reduced. Therefore, in the modification according to the present embodiment, as shown in (b) of FIG. 8, the first protruding portion 161 of the first planar member 101 may be formed such that the battery module 30 can be disposed in a manner of avoiding the first protruding portion 161 of the first planar member 101. Accordingly, it is possible to prevent the reduction in area of the first planar member 101 in contact with the bottom surface of the battery module 30. Accordingly, it is possible to prevent the reduction in cooling effect of the battery module 30.

### Second Embodiment

In a second embodiment, the same reference numerals are given to the components described in the first embodiment, and a description thereof may be omitted. Further, a content of the second embodiment can be combined with the content of the first embodiment.

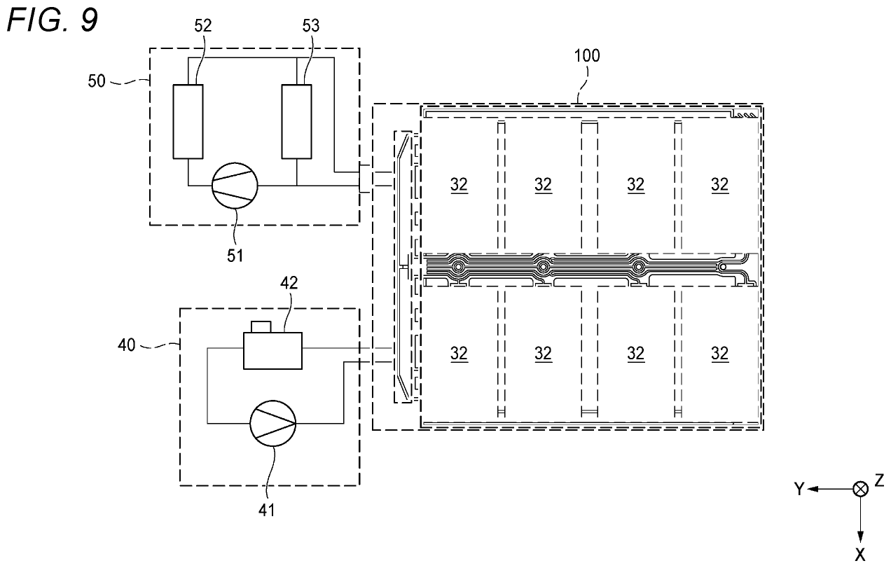

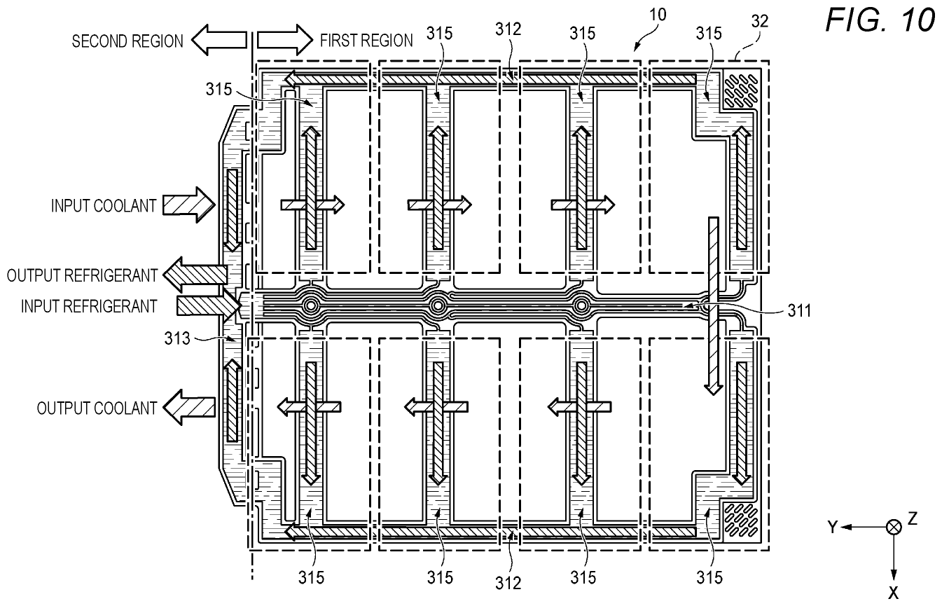

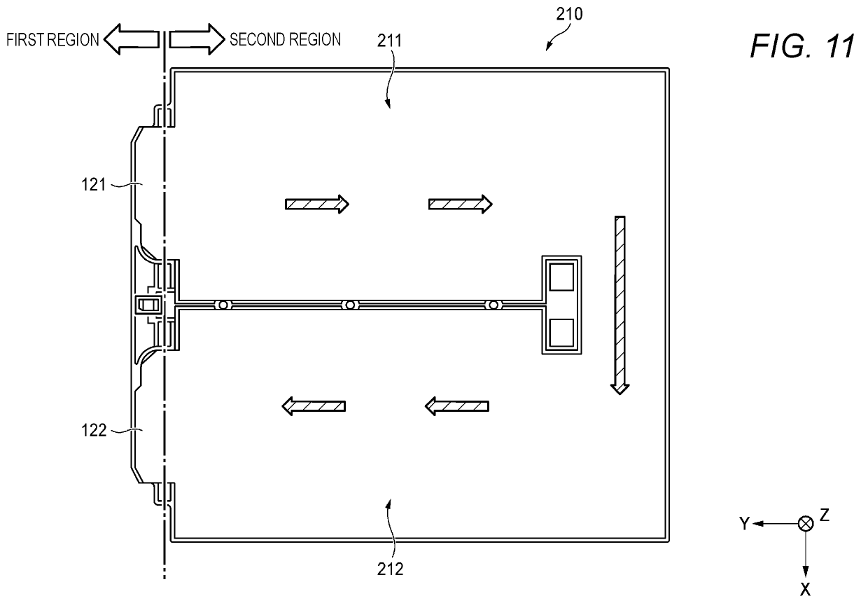

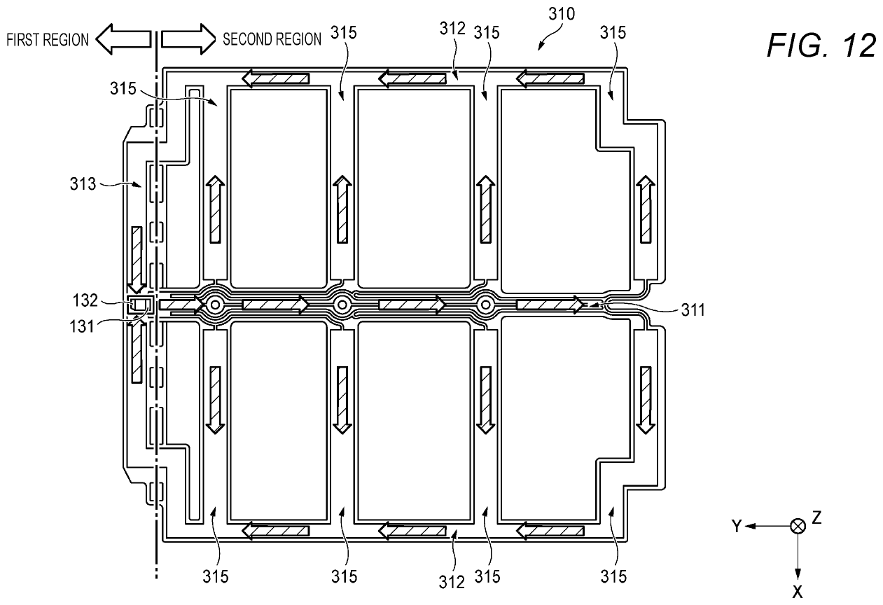

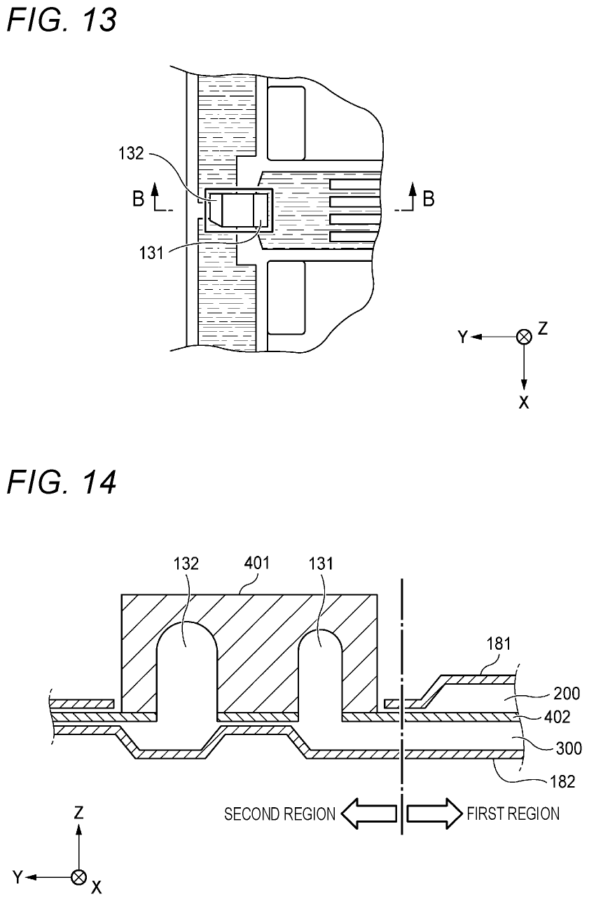

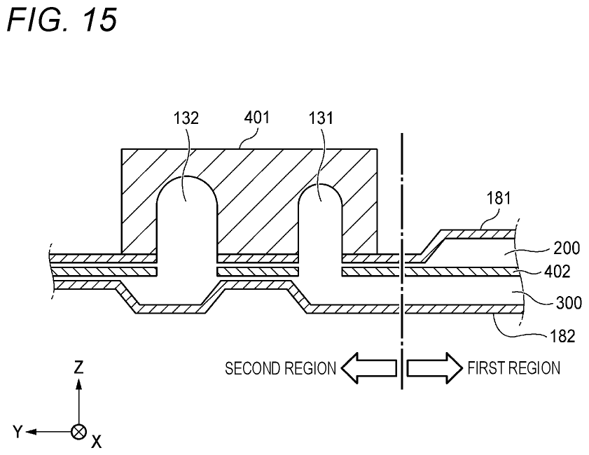

A configuration of the heat exchange plate 100 according to the second embodiment will be described with reference to FIGS. 9 to 15. The heat exchange plate 100 is mounted on the vehicle 1 as described in the first embodiment. FIG. 9 is a schematic view showing a configuration example of a battery cooling system including the heat exchange plate 100 and the refrigerant circuit 50 and the coolant circuit 40 connected to the heat exchange plate 100. FIG. 10 is a plan view showing a configuration example of the heat exchange plate 100. FIG. 11 is a plan view showing a configuration example of the coolant flow path 210 provided in the heat exchange plate 100. FIG. 12 is a plan view showing a configuration example of the refrigerant flow path 310 provided in the heat exchange plate 100. FIG. 13 is a plan view showing a configuration example of the vicinity of the refrigerant input portion 131 and the refrigerant output portion 132 in the refrigerant flow path 310. FIG. 14 is a cross-sectional view showing a first example of a cross section taken along a line B-B in FIG. 13. FIG. 15 is a cross-sectional view showing a second example of the cross section taken along the line B-B in FIG. 13. FIGS. 9 to 12 and FIGS. 17 to 21 to be described later are plan views when the heat exchange plate 100 is viewed from the lower side to the upper side (from a negative direction of the Z axis toward a positive direction of the Z axis).

The vehicle 1 includes the coolant circuit 40 including at least a pump 41. The coolant circuit 40 may further include a reservoir tank 42. The coolant circuit 40 is connected to the coolant layer 200 of the heat exchange plate 100. A coolant circulates through the coolant circuit 40 and the coolant layer 200.

The vehicle 1 includes the refrigerant circuit 50 including at least a compressor 51 and a condenser 52. The refrigerant circuit 50 may further include an air conditioning evaporator 53 for an interior of a vehicle. The refrigerant circuit 50 is connected to the refrigerant layer 300 of the heat exchange plate 100. A refrigerant circulates through the refrigerant circuit 50 and the refrigerant layer 300.

The heat exchange plate 100 includes a first surface 181 disposed along a predetermined plane and a second surface 182 opposite to the first surface 181. In the present embodiment, the first surface 181 is referred to as an upper surface, and the second surface 182 is referred to as a lower surface. However, the first surface 181 may be the lower surface, and the second surface 182 may be the upper surface. Further, the predetermined plane may be a floor of the vehicle body 2.

The heat exchange plate 100 includes the coolant layer 200 that allows the coolant to circulate between the first surface 181 and the second surface 182. In addition, the heat exchange plate 100 includes the refrigerant layer 300 that allows the refrigerant to circulate between the first surface 181 and the second surface 182. In the present embodiment, a configuration in which the coolant layer 200 is provided above the refrigerant layer 300 will be described. However, the configuration may be a configuration in which the coolant layer 200 is provided above the coolant layer 200.

The first surface 181 includes a first region that is a region in which a battery cell group 32 is disposed, and a second region that is a region in which the battery cell group 32 is not disposed. That is, the battery cell group 32 may not be disposed in the second region of the first surface 181. The first region and the second region may be regions viewed from a normal direction of the predetermined plane (for example, the floor of the vehicle body 2). In the present embodiment, although the battery cell group 32 is disposed in the first region in the present embodiment, the battery module group 31 including the battery cell group 32 may be disposed in the first region. Further, the battery pack 10 may include a plurality of the battery module groups 31.

The refrigerant layer 300 includes the refrigerant input portion 131 through which the refrigerant enters the refrigerant layer 300 from the refrigerant circuit 50, and the refrigerant output portion 132 through which the refrigerant exits from the refrigerant layer 300 to the refrigerant circuit 50.

The coolant layer 200 includes the coolant input portion 121 through which the coolant enters the coolant layer 200 from the coolant circuit 40, and the coolant output portion 122 through which the coolant exits from the coolant layer 200 to the coolant circuit 40.

At least one of the coolant input portion 121 and the coolant output portion 122 is disposed in the second region.

The refrigerant flow path 310 in the refrigerant layer 300 is formed across the first region and the second region.

As shown in FIGS. 13 to 15, the refrigerant input portion 131 and the refrigerant output portion 132 are connected to the refrigerant layer 300 by a refrigerant flange 401. As shown in FIG. 14, the refrigerant flange 401 may be joined to a plate 402 that separates the refrigerant layer 300 and the coolant layer 200, or may be joined to a plate that forms the upper surface (first surface 181) of the coolant layer 200 as shown in FIG. 15. As shown in FIG. 14 or 15, the refrigerant output portion 132 is disposed in the second region. In addition, as shown in FIG. 14 or 15, the refrigerant input portion 131 may be disposed in a position closer to the first region than the refrigerant output portion 132 in the second region.

For example, the refrigerant flow path 310 in the refrigerant layer 300 includes a first refrigerant flow path 311 connected to the refrigerant input portion 131, a plurality of branch refrigerant flow paths 315 branching from the first refrigerant flow path 311, a second refrigerant flow path 312 where the plurality of branch refrigerant flow paths 315 converge, and a third refrigerant flow path 313 connected to the refrigerant output portion 132 from the second refrigerant flow path 312. Here, at least a part of the third refrigerant flow path 313 is provided in the second region.

For example, the coolant flow path 210 in the coolant layer 200 includes a first coolant flow path 211 that is connected to the coolant input portion 121 and disposed along a predetermined direction, and a second coolant flow path 212 that is connected to the first coolant flow path 211, disposed along the predetermined direction, and connected to the coolant output portion 122. The predetermined direction may be a traveling direction of the vehicle 1. At least a part of the first coolant flow path 211 may intersect (for example, be orthogonal to) at least a part of the branch refrigerant flow paths 315 when viewed from the normal direction of the predetermined plane (for example, the floor of the vehicle body 2) in the second region. At least a part of the second coolant flow path 212 may intersect (for example, be orthogonal to) at least a part of the branch refrigerant flow paths 315 when viewed from the normal direction of the predetermined plane in the second region.

According to the above-described configuration, heat can be exchanged between the refrigerant flowing through the refrigerant flow path 310 and the coolant flowing through the coolant flow path 210 in the second region that is not subjected to a heat load caused by the battery cell group 32.

For example, a minimum temperature of the coolant in the first region is set to T1, and a temperature rise of the coolant caused by flowing through the coolant circuit 40 outside the heat exchange plate 100 is set to T2. In this case, a temperature of the coolant in the second region can be decreased to T1−T2. That is, the minimum temperature of the coolant in the second region may be T1−T2. Accordingly, the minimum temperature of the coolant in the first region can be set to a more appropriate temperature by appropriately forming the second region which is not subjected to the heat load caused by the battery cell group 32 and controlling the heat exchange in the second region. Accordingly, the battery cell group 32 disposed in the first region can be made to have a more appropriate temperature.

At least one of a heat transfer fin and a heat transfer rib may be provided in the refrigerant flow path 310 to promote the heat exchange. Further, at least one of the heat transfer fin and the heat transfer rib is provided in a portion of the coolant flow path 210 adjacent to the refrigerant flow path 310 to promote the heat exchange.

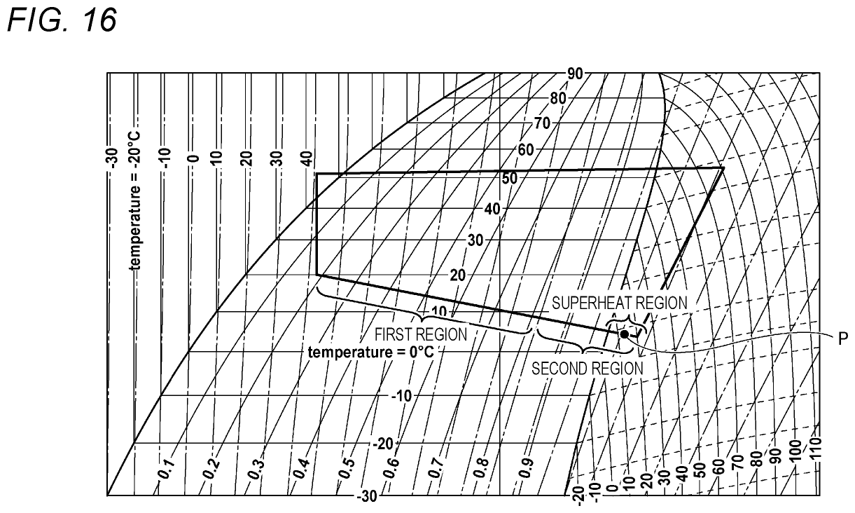

FIG. 16 shows an example of a p-h diagram relating to the refrigerant flowing through the refrigerant circuit 50 and the refrigerant flow path 310 shown in FIGS. 9 and 10. In the p-h diagram shown in FIG. 16, a vertical axis represents a pressure, and a horizontal axis represents a specific enthalpy. FIG. 16 is the p-h diagram in a configuration in which the refrigerant output portion 132 is disposed in the second region and the refrigerant input portion 131 is disposed in the position closer to the first region than the refrigerant output portion 132 in the second region, as described above.

For example, as shown in FIG. 16, in the first region, a temperature of the refrigerant decreases from 20 degrees to 10 degrees, and a pressure of the refrigerant decreases from 0.47 MPaG to 0.31 MPaG. Further, for example, in the second region, the temperature of the refrigerant further decreases from 10 degrees to 5 degrees, and the pressure of the refrigerant further decreases from 0.31 MPaG to 0.25 MPaG.

As shown in a configuration of the refrigerant flow path 310 in FIG. 12, in a downstream portion of the refrigerant flow path 310, the pressure of the refrigerant may decrease due to a pressure loss. If the downstream portion of the refrigerant flow path 310 is provided in the first region, a local temperature decrease may occur in the first region. In contrast, in the present embodiment, the downstream portion of the refrigerant flow path 310 is provided in the second region. Accordingly, the local temperature decrease in the first region can be prevented.

In a most downstream portion (for example, in the vicinity of the refrigerant output portion 132) of the refrigerant flow path 310, the refrigerant may be gasified and the temperature may rise. If the most downstream portion of the refrigerant flow path 310 is provided in the first region, a local temperature rise may occur in the first region. In contrast, in the present embodiment, the most downstream portion of the refrigerant flow path 310 is provided in the second region. Accordingly, the local temperature rise in the first region can be prevented.

If dry-out is promoted in the first region, a temperature rise may occur in the first region. In contrast, in the present embodiment, the dry-out can be promoted in the second region. Accordingly, superheat (degree of superheat) of the refrigerant output portion 132 (that is, an evaporator outlet) can be secured without the temperature rise in the first region, and a flow rate of the refrigerant can be increased. For example, a thermal expansion valve (TXV) may be provided in the vicinity of the refrigerant output portion 132 of the second region, and the thermal expansion valve may operate to detect the temperature of the refrigerant in the vicinity of the refrigerant output portion 132 of the second region (that is, an outlet of the second region) at a point P in FIG. 16, and adjust the flow rate of the refrigerant according to the detected temperature. For example, the thermal expansion valve may operate to increase the flow rate of the refrigerant when the detected temperature of the refrigerant is higher than a predetermined first threshold. Further, the thermal expansion valve may operate to reduce the flow rate of the refrigerant when the detected temperature of the refrigerant is lower than a predetermined second threshold value.

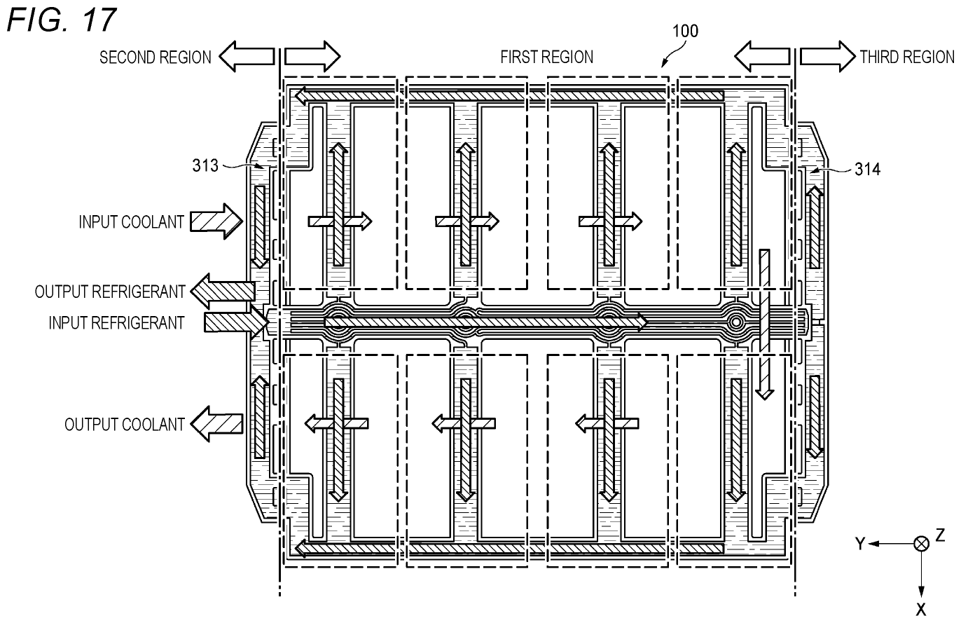

FIG. 17 is a plan view showing a first modification of a configuration of the heat exchange plate 100.

As shown in FIG. 17, the first surface 181 of the heat exchange plate 100 may further include a third region, which is a region in which the battery cell group 32 is not disposed, on a side opposite to the second region across the first region. The refrigerant flow path 310 in the refrigerant layer 300 may be formed to extend over the first region, the second region, and the third region.

For example, an end opposite to the refrigerant input portion 131 of the first refrigerant flow path 311 may extend to the third region, and a fourth refrigerant flow path 314 connected to the second refrigerant flow path 312 from the end may be provided in the third region.

It is difficult for the refrigerant to flow through a portion of the refrigerant flow path 310 far from the refrigerant input portion 131, and a temperature of the coolant in a folded portion from the first coolant flow path 211 to the second coolant flow path 212 tends to increase. In contrast, according to the configuration shown in FIG. 17, the heat can be exchanged between the refrigerant flowing through the fourth refrigerant flow path 314 and the coolant flowing through the folded portion from the first coolant flow path 211 to the second coolant flow path 212 in the third region which is not subjected to the heat load of the battery cell group 32. Accordingly, the coolant is cooled in the third region, and uniformity of the temperature of the coolant is improved.

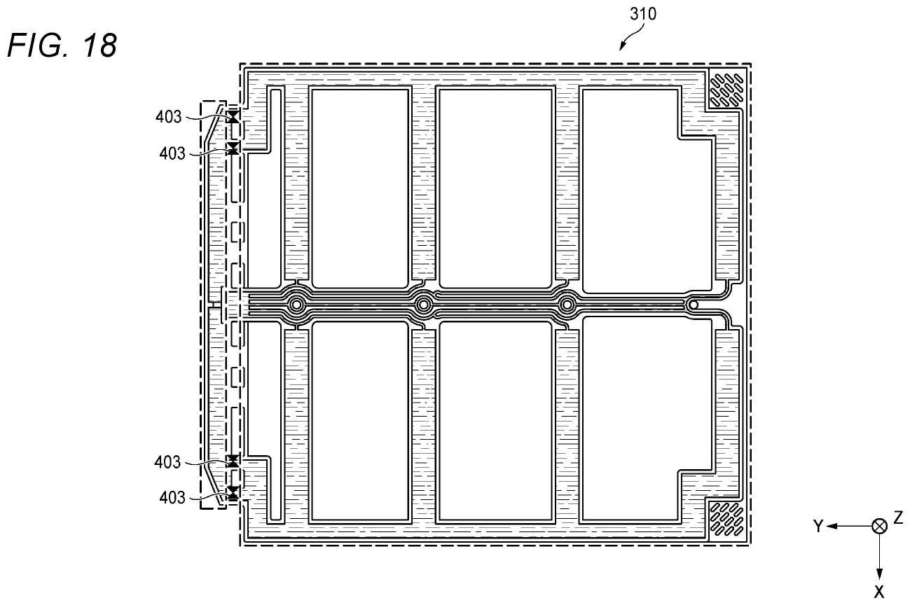

FIG. 18 is a plan view showing a second modification of the configuration of the heat exchange plate 100.

As shown in FIG. 18, the refrigerant flow path 310 in the refrigerant layer 300 may further include throttle portions 403 each of which throttles the flow rate of the refrigerant between the second refrigerant flow path 312 and the third refrigerant flow path 313. A pressure of the refrigerant in the third refrigerant flow path 313 may be lower than a pressure of the refrigerant in the second refrigerant flow path 312. Accordingly, an evaporation temperature of the refrigerant in the second region can be further reduced.

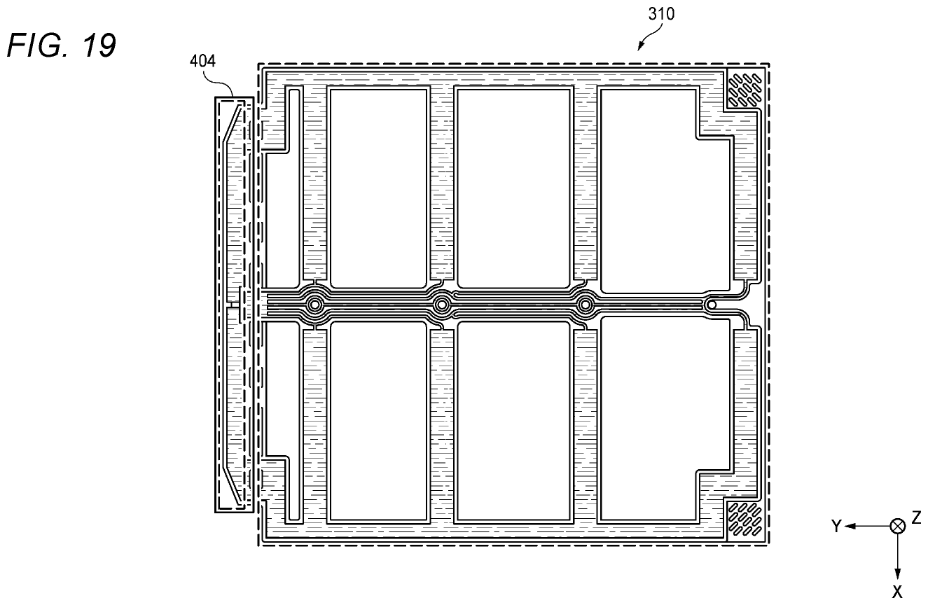

FIG. 19 is a plan view showing a third modification of the configuration of the heat exchange plate 100.

The heat exchange plate 100 may include, in at least a part of the first region of the heat exchange plate 100, a heat conductive member disposed between the battery cell group 32 and the heat exchange plate 100 and having a first heat conductivity. In addition, as shown in FIG. 19, the heat exchange plate 100 may, in at least a part of the second region of the heat exchange plate 100, include a heat insulating member 404 having a second heat conductivity. The first heat conductivity may be greater than the second heat conductivity. For example, the first heat conductivity may be 100 times or more the second heat conductivity.

In this way, it is possible to prevent an occurrence of dew condensation water in the second region where a temperature becomes low by providing the heat insulating member 404 in at least a part of the second region. In addition, by providing the heat insulating member 404 in at least a part of the second region, the dew condensation water generated in the second region can be prevented from approaching a high-voltage power system that outputs electric power of the battery cell group 32.

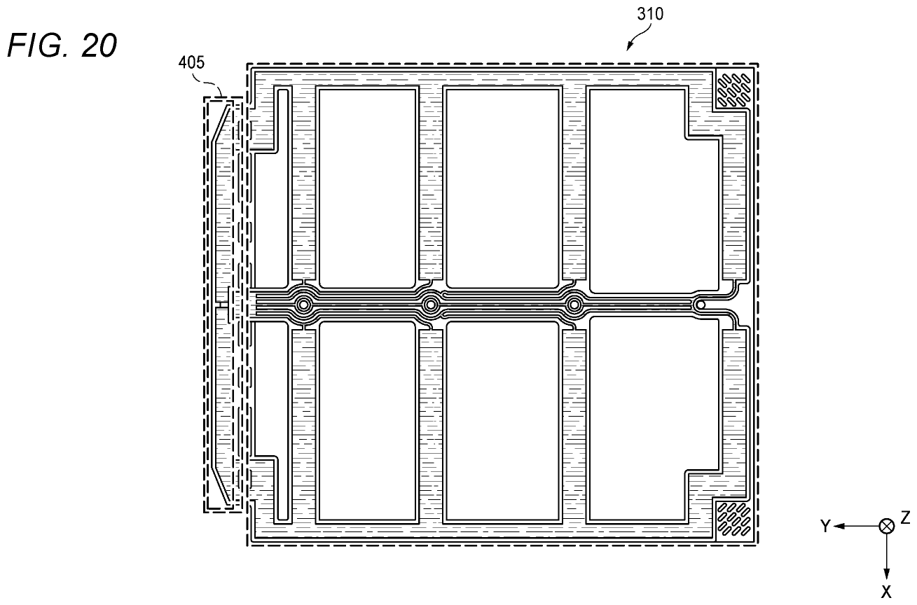

FIG. 20 is a plan view showing a fourth modification of the configuration of the heat exchange plate 100.

As shown in FIG. 20, the heat exchange plate 100 may further include, in the second region of the heat exchange plate 100, a condensed water recovery portion 405 that recovers condensed water generated in a portion including the second region of the heat exchange plate 100.

Accordingly, the condensed water that can be generated in the second region where the temperature becomes low is recovered in the condensed water recovery portion 405, so that the condensed water generated in the second region can be prevented from approaching the high-voltage power system that outputs the electric power of the battery cell group 32.

In addition, the condensed water recovery portion 405 may be configured to discharge the recovered condensed water to a condensed water storage portion (not shown) provided outside the battery pack 10. Moisture stored in the condensed water storage portion may be adsorbed by a desiccant.

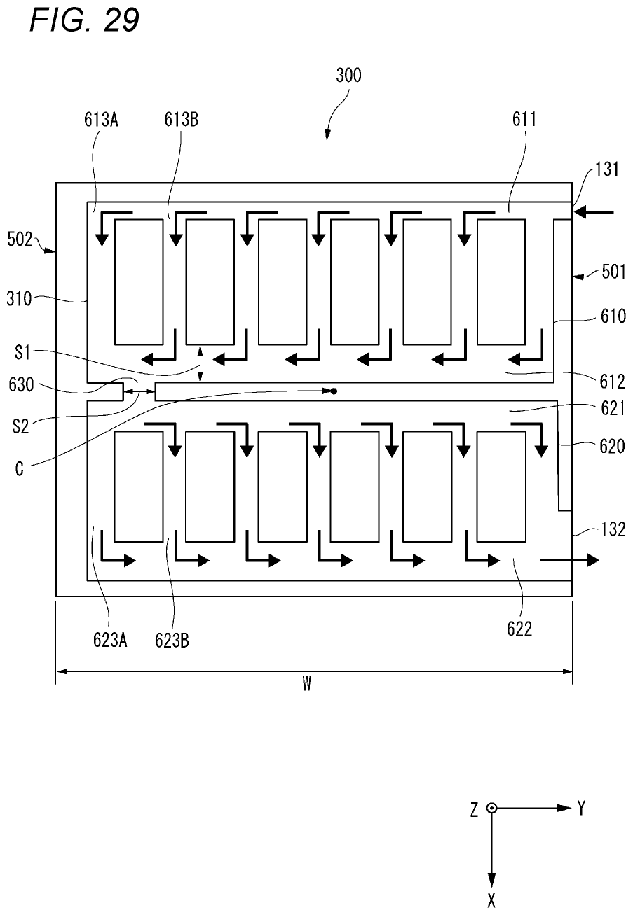

The configurations shown in FIGS. 18, 19, and 20 may be appropriately combined. For example, the heat exchange plate 100 may include at least two of the throttle portion 403 shown in FIG. 18, the heat insulating member 404 shown in FIG. 19, and the condensed water recovery portion 405 shown in FIG. 29.

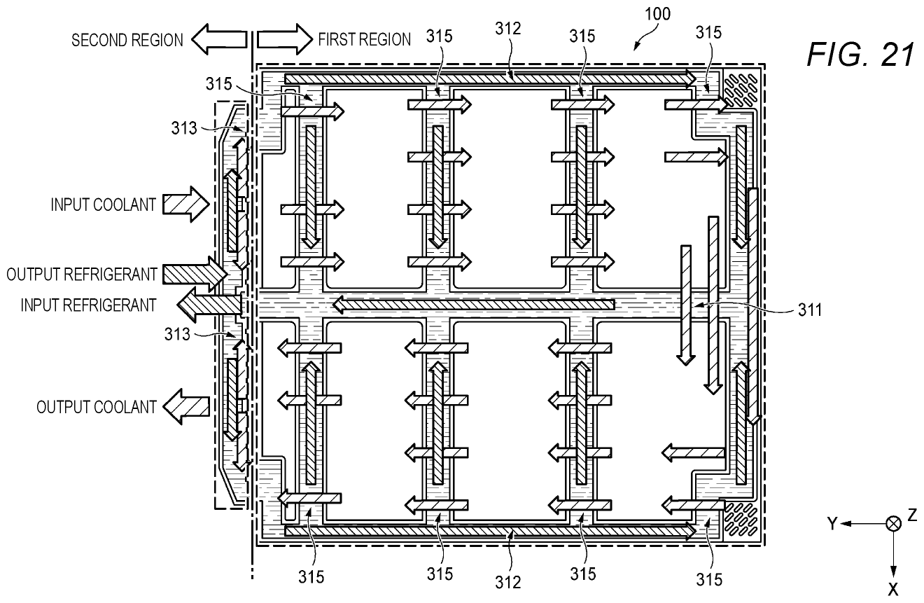

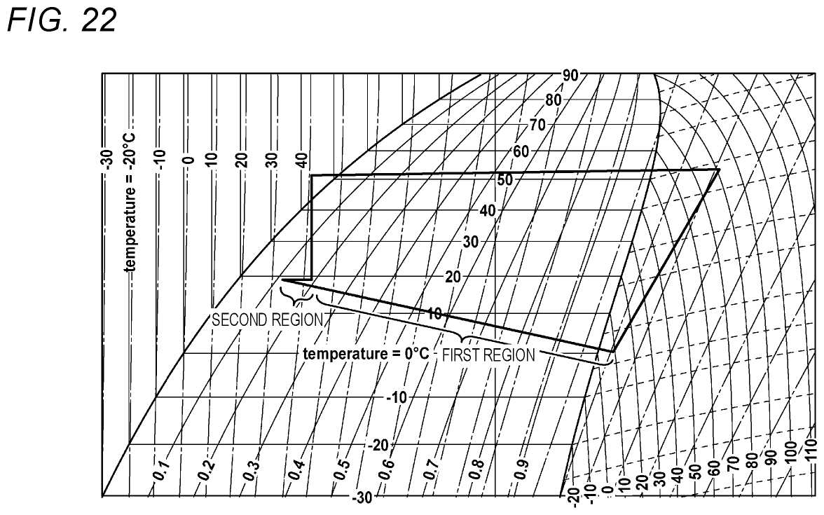

FIG. 21 is a plan view showing a fifth modification of the configuration of the heat exchange plate 100. FIG. 22 shows an example of a p-h diagram relating to the refrigerant flowing through the refrigerant circuit 50 and the refrigerant flow path 310 shown in FIG. 21. In the p-h diagram shown in FIG. 21, a vertical axis represents a pressure, and a horizontal axis represents a specific enthalpy.

As shown in FIG. 21, the refrigerant flow path 310 in the refrigerant layer 300 of the heat exchange plate 100 may include the third refrigerant flow path 313 connected to the refrigerant input portion 131, the second refrigerant flow path 312 connected to the third refrigerant flow path 313 and disposed along a predetermined direction, a plurality of branch refrigerant flow paths 315 branching from the second refrigerant flow path 312, and a first refrigerant flow path 311 where the plurality of branch refrigerant flow paths 315 converge and which is connected to the refrigerant output portion 132. At least a part of the third refrigerant flow path 313 may be provided in the second region. That is, the refrigerant flowing from the refrigerant input portion 131 flows through the third refrigerant flow path 313, the second refrigerant flow path 312, the branch refrigerant flow paths 315, and the first refrigerant flow path 311 in this order, and flows out from the refrigerant output portion 132.

Since the temperature of the refrigerant tends to decrease from the refrigerant input portion 131 toward the refrigerant output portion 132 due to a pressure loss of the refrigerant flow path 310, the temperature of the refrigerant may have the following relationship.

A temperature of the refrigerant of the refrigerant input portion 131>a temperature of the coolant of the coolant input portion 121>a temperature of the coolant of the coolant output portion 122>a temperature of the refrigerant of the refrigerant output portion 132

In this case, according to the configuration shown in FIG. 21, since the refrigerant flowing into the refrigerant flow path 310 exchanges the heat with the coolant in the second region, the refrigerant is cooled as shown in FIG. 22, so that cooling efficiency in the first region can be improved.

The configurations shown in FIGS. 18, 19, and 20 can be appropriately combined with the heat exchange plate 100 shown in FIG. 21. For example, the heat exchange plate 100 shown in FIG. 21 may have a configuration including at least one of the throttle portion 403 shown in FIG. 18, the heat insulating member 404 shown in FIG. 19, and the condensed water recovery portion 405 shown in FIG. 29.

### Third Embodiment

In a third embodiment, the same reference numerals are given to the components described in the first or second embodiment, and the description thereof may be omitted. Further, a content of the third embodiment can be combined with at least one of the first and second embodiments.

<First Configuration Example>

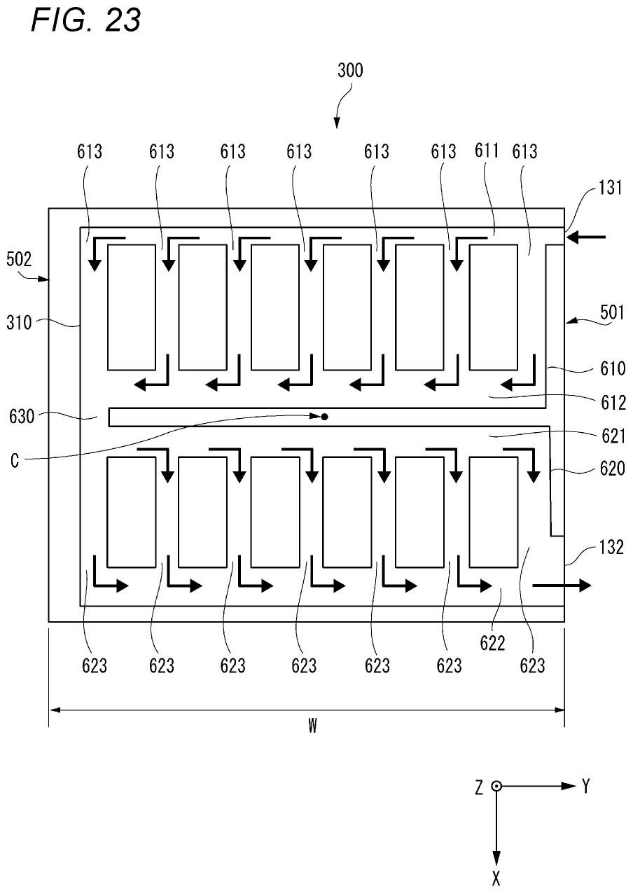

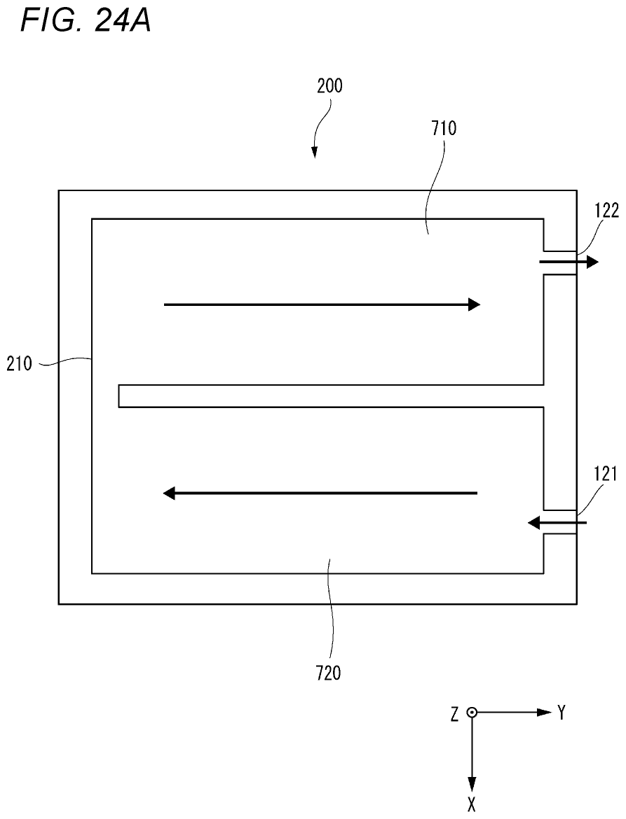

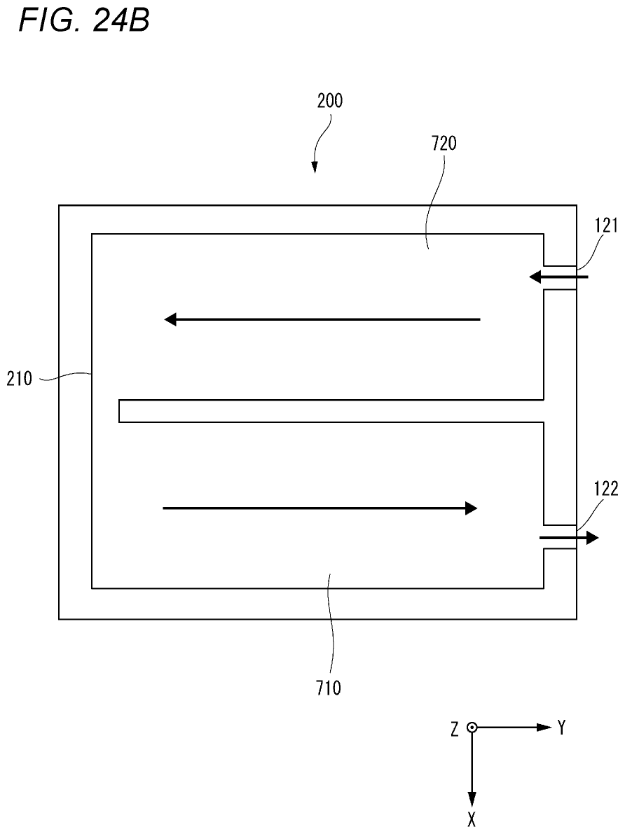

FIG. 23 is a plan view showing a first configuration example of the refrigerant layer 300 of the heat exchange plate 100. FIG. 24A and FIG. 24B are plan views showing configuration examples of the coolant layer 200 of the heat exchange plate 100. In FIG. 23, arrows indicate directions in which a refrigerant flows. This is also applied to another drawings of the refrigerant layer 300 in the third embodiment. In FIGS. 24A and 24B, arrows indicate directions in which the coolant flows.

As described in the first or second embodiment, the heat exchange plate 100 is mounted on the vehicle 1. As shown in FIG. 9, the vehicle 1 includes the refrigerant circuit 50 including at least the compressor 51 and the condenser 52. As shown in FIG. 9, the vehicle 1 includes the coolant circuit 40 including at least the pump 41.

The heat exchange plate 100 includes a first surface 181 disposed along a predetermined plane and a second surface 182 opposite to the first surface 181. In the present embodiment, the first surface 181 is referred to as an upper surface, and the second surface 182 is referred to as a lower surface. However, the first surface 181 may be the lower surface, and the second surface 182 may be the upper surface. The predetermined plane may be the floor of the vehicle body 2.

The heat exchange plate 100 includes the coolant layer 200 that allows the coolant to circulate between the first surface 181 and the second surface 182. The heat exchange plate 100 includes the refrigerant layer 300 that allows the refrigerant to circulate between the first surface 181 and the second surface 182. As shown in FIG. 14 or 15, the coolant layer 200 is disposed above the refrigerant layer 300. In this case, the battery cell group 32 may be disposed above the coolant layer 200. However, an arrangement of the coolant layer 200 and the refrigerant layer 300 is not limited thereto, and, for example, the refrigerant layer 300 may be disposed above the coolant layer 200. In this case, the battery cell group 32 may be disposed above the refrigerant layer 300.

The heat exchange plate 100 has a first end portion 501 in a predetermined direction and a second end portion 502 opposite to the first end portion 501 in the predetermined direction. The predetermined direction is a direction in which the vehicle 1 is movable by the first wheel 3a and the second wheel 3b, and may be, for example, a traveling direction of the vehicle 1.

The refrigerant layer 300 includes the refrigerant input portion 131 which is disposed at the first end portion 501 and through which the refrigerant enters the refrigerant layer 300 from the refrigerant circuit 50, and the refrigerant output portion 132 which is disposed at the first end portion 501 and through which the refrigerant exits from the refrigerant layer 300 to the refrigerant circuit 50. The refrigerant layer 300 includes a first refrigerant flow path 610 that is connected to the refrigerant input portion 131 and disposed along the predetermined direction, a second refrigerant flow path 620 that is connected to the refrigerant output portion 132 and disposed along the predetermined direction, and a connection portion 630 that connects the first refrigerant flow path 610 and the second refrigerant flow path 620.

The first refrigerant flow path 610 includes a first branch portion 611, a first converging portion 612, and a plurality of first branch flow paths 613 connecting the first branch portion 611 and the first converging portion 612. The second refrigerant flow path 620 includes a second branch portion 621, a second converging portion 622, and a plurality of second branch flow paths 623 connecting the second branch portion 621 and the second converging portion 622. The refrigerant can move through the refrigerant input portion 131, the first branch portion 611, the first branch flow path 613, the first converging portion 612, the connection portion 630, the second branch portion 621, the second branch flow path 623, the second converging portion 622, and the refrigerant output portion 132 in this order.

The connection portion 630 is disposed closer to the second end portion 502 than a midpoint C of the refrigerant layer 300 in the predetermined direction. The midpoint C may be a point bisecting a width W of the refrigerant layer 300 in the predetermined direction. However, an arrangement of the connection portion 630 is not limited thereto. For example, when the width W of the refrigerant layer 300 in the predetermined direction is divided into four equal portions, the connection portion 630 may be disposed closer to the second end portion 502 than a point closest to the second end portion 502 side. Alternatively, when the width W of the refrigerant layer 300 in the predetermined direction is divided into eight equal portions, the connection portion 630 may be disposed closer to the second end portion 502 than a point closest to the second end portion 502 side. Alternatively, when the width W of the refrigerant layer 300 in the predetermined direction is divided into 16 equal portions, the connection portion 630 may be disposed closer to the second end portion 502 than a point closest to the second end portion 502 side.

The coolant layer 200 includes the coolant input portion 121 through which the coolant enters the coolant layer 200 from the coolant circuit 40, and the coolant output portion 122 through which the coolant exits from the coolant layer 200 to the coolant circuit 40. The coolant input portion 121 and the coolant output portion 122 may be disposed at the first end portion 501. The coolant layer 200 includes the coolant flow path 210. For example, the coolant layer 200 is connected to the coolant input portion 121 or the coolant output portion 122, and is disposed along the predetermined direction, and at least a part thereof includes a first coolant flow path 710 disposed in a manner of overlapping with the first refrigerant flow path 610. The coolant layer 200 is connected to the coolant output portion 122 or the coolant input portion 121, is connected to the first coolant flow path 710, and is disposed along the predetermined direction, and at least a part thereof includes a second coolant flow path 720 that is disposed in a manner of overlapping with the second refrigerant flow path 620. The coolant can move through the coolant input portion 121, the first coolant flow path 710, the second coolant flow path 720, and the coolant output portion 122.

At least a part of the plurality of first branch flow paths 613 may be arranged along a direction intersecting (for example, orthogonal to) the predetermined direction when viewed from a normal direction of a predetermined plane. At least a part of the plurality of second branch flow paths 623 may be arranged along a direction intersecting (for example, orthogonal to) a predetermined direction when viewed from the normal direction of the predetermined plane.

In this way, by disposing both the refrigerant input portion 131 and the refrigerant output portion 132 at the first end portion 501, for example, a distance between the refrigerant input portion 131 and the refrigerant output portion 132 can be shortened as compared with a case in which the refrigerant input portion 131 is disposed at the first end portion 501 and the refrigerant output portion 132 is disposed at the second end portion 502. This facilitates connection between the refrigerant input portion 131 and the refrigerant circuit 50 and connection between the refrigerant output portion 132 and the refrigerant circuit 50.

In addition, according to a configuration shown in FIG. 23, while the refrigerant input portion 131 and the refrigerant output portion 132 are both disposed at the first end portion 501, distances of respective paths that reach the connection portion 630 from the refrigerant input portion 131 in the first refrigerant flow path 610 can be made substantially the same, and distances of respective paths that reach the refrigerant output portion 132 from the connection portion 630 in the second refrigerant flow path 620 can be made substantially the same. Accordingly, the refrigerant can flow more uniformly into the refrigerant flow path 310 including a portion close to the second end portion 502. That is, it is possible to reduce a difference (that is, a temperature difference) between a temperature control capability of a portion of the heat exchange plate 100 close to the first end portion 501 in which the refrigerant input portion 131 and the refrigerant output portion 132 are disposed and a temperature control capability of a portion of the heat exchange plate 100 close to the second end portion 502 opposite to the first end portion 501.

As shown in FIGS. 23 and 24A, an orientation of movement in the predetermined direction of the refrigerant moving in the first refrigerant flow path 610 may be opposite to an orientation of movement in the predetermined direction of the coolant moving in the first coolant flow path 710. The orientation of the movement of the refrigerant moving in the second refrigerant flow path 620 in the predetermined direction may be opposite to the orientation of the movement of the coolant moving in the second coolant flow path 720 in the predetermined direction.

For example, a first refrigerant orientation in the predetermined direction of the refrigerant moving in the first refrigerant flow path 610 may be opposite to a first coolant orientation in the predetermined direction of the coolant moving in the first coolant flow path 710. A second refrigerant orientation in the predetermined direction of the refrigerant moving in the second refrigerant flow path 620 may be opposite to a second coolant orientation in the predetermined direction of the coolant moving in the second coolant flow path 720.

Accordingly, even if a deviation of a temperature occurs in the refrigerant flow path 310, the heat exchange is performed between the refrigerant and the coolant, so that a deviation of a temperature in the heat exchange plate 100 can be alleviated.

The configuration of the coolant layer 200 is not limited to a configuration shown in FIG. 24A, and may be, for example, a configuration shown in FIG. 24B. In this case, the orientation of the movement of the refrigerant moving in the first refrigerant flow path 610 in the predetermined direction may be the same as the orientation of the movement of the coolant moving in the first coolant flow path 710 in the predetermined direction. The orientation of the movement of the refrigerant moving in the second refrigerant flow path 620 in the predetermined direction may be the same as the orientation of the movement of the coolant moving in the second coolant flow path 720 in the predetermined direction.

For example, the first refrigerant orientation in the predetermined direction of the refrigerant moving in the first refrigerant flow path 610 may the same as the first coolant orientation in the predetermined direction of the coolant moving in the first coolant flow path 710. The second refrigerant orientation in the predetermined direction of the refrigerant moving in the second refrigerant flow path 620 may be opposite to the second coolant orientation in the predetermined direction of the coolant moving in the second coolant flow path 720.

Accordingly, even if a deviation of a temperature occurs in the refrigerant flow path 310, the heat exchange is performed between the refrigerant and the coolant, so that a deviation of a temperature in the heat exchange plate 100 can be alleviated.

<Second Configuration Example>

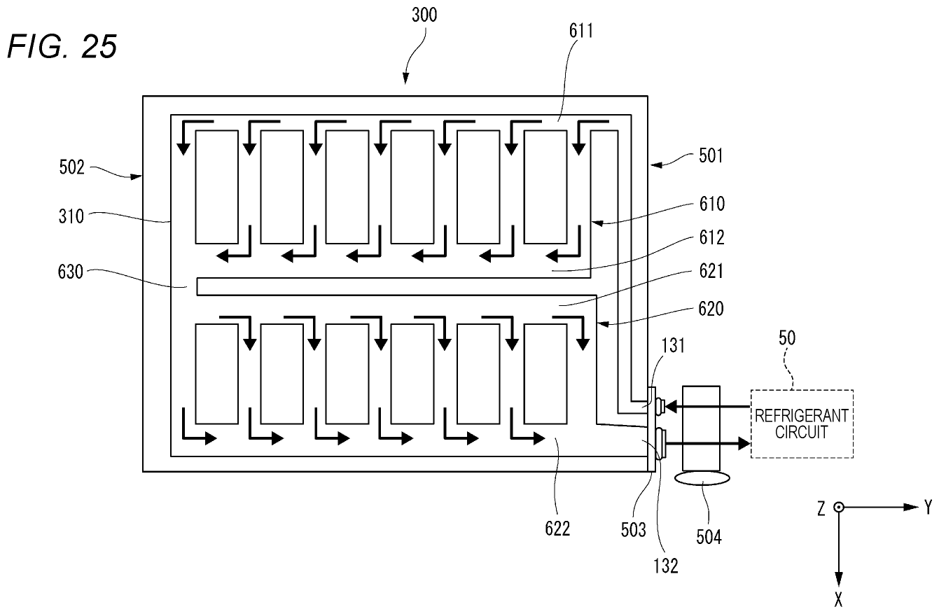

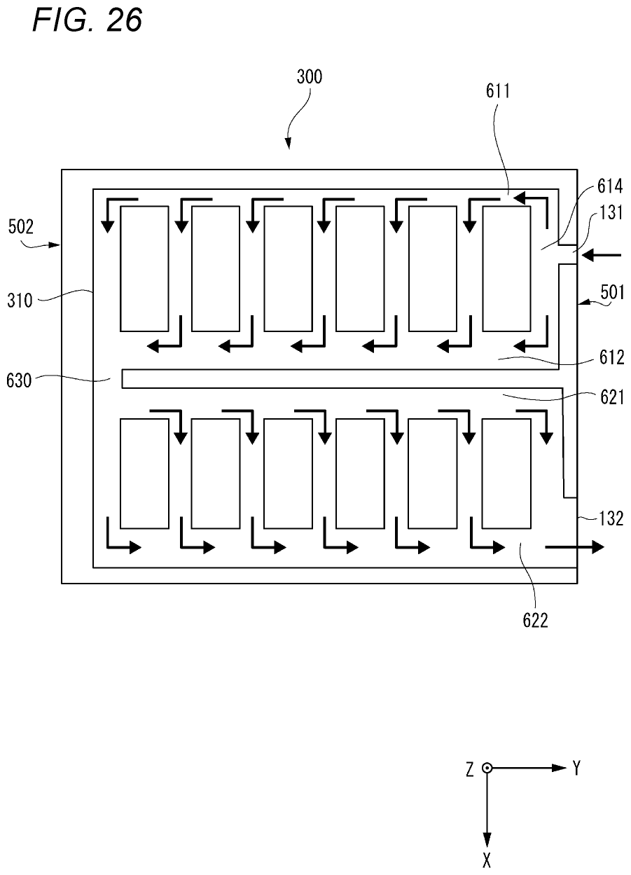

FIG. 25 is a plan view showing a second configuration example of the refrigerant layer 300 of the heat exchange plate 100.

As shown in FIG. 25, the refrigerant input portion 131 and the refrigerant output portion 132 may be adjacent to each other at the first end portion 501, and an integrated piping joint 503 and a thermal expansion valve 504 (TXV) may be disposed between the refrigerant input portion 131 and the refrigerant circuit 50, and between the refrigerant output portion 132 and the refrigerant circuit 50.

According to the configuration shown in FIG. 25, it is possible to reduce a cost as compared with a case in which respective piping joints 503 and thermal expansion valves 504 are disposed in the refrigerant input portion 131 and the refrigerant output portion 132.

The thermal expansion valve 504 may adjust an amount of the refrigerant input to the refrigerant input portion 131 according to a temperature of the refrigerant output from the refrigerant output portion 132. Accordingly, the flow rate and the temperature of the refrigerant in the refrigerant layer 300 can be appropriately adjusted.

<Third Configuration Example>

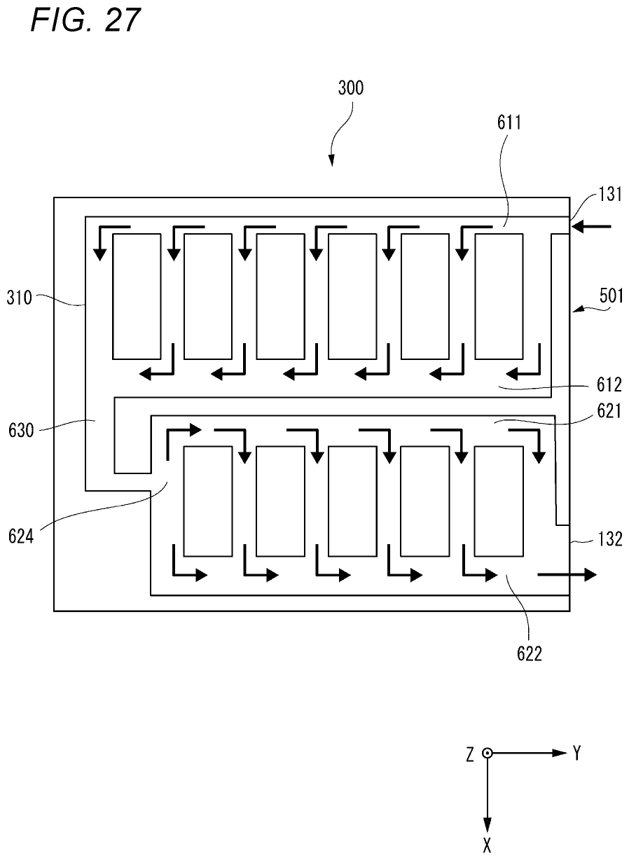

FIG. 26 is a plan view showing a third configuration example of the refrigerant layer 300 of the heat exchange plate 100.

As shown in FIG. 26, the first refrigerant flow path 610 may include a third branch portion 614. The third branch portion 614 may be connected to the refrigerant input portion 131, the first branch portion 611, and the first converging portion 612. The refrigerant input to the refrigerant input portion 131 may branch into a flow to the first branch portion 611 and a flow to the first converging portion 612 at the third branch portion 614.

According to a configuration shown in FIG. 26, the refrigerant input to the refrigerant input portion 131 can flow more uniformly in both the first branch portion 611 and the second converging portion 622 at the third branch portion 614. Accordingly, it is possible to cause the refrigerant to flow more uniformly in the first refrigerant flow path 610.

<Fourth Configuration Example>

FIG. 27 is a plan view showing a fourth configuration example of the refrigerant layer 300 of the heat exchange plate 100.

As shown in FIG. 27, the second refrigerant flow path 620 may include a fourth branch portion 624. The fourth branch portion 624 may be connected to the connection portion 630, the second branch portion 621, and the second converging portion 622. The refrigerant passing through the connection portion 630 may branch into a flow to the second branch portion 621 and a flow to the second converging portion 622 at the fourth branch portion 624.

According to the configuration shown in FIG. 27, the refrigerant passing through the connection portion 630 can flow more uniformly in both the second branch portion 621 and the second converging portion 622 at the fourth branch portion 624. Accordingly, it is possible to cause the refrigerant to flow more uniformly in the second refrigerant flow path 620.

<Fifth Configuration Example>

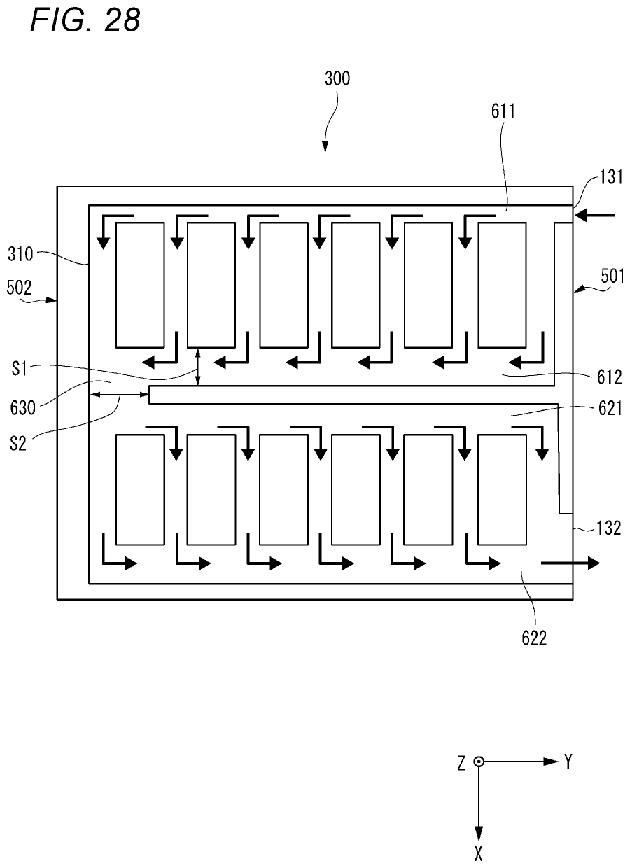

FIG. 28 is a plan view showing a fifth configuration example of the refrigerant layer 300 of the heat exchange plate 100.

As shown in FIG. 28, a cross-sectional area S2 of the refrigerant flow path 310 of the connection portion 630 may be larger than a cross-sectional area S1 of the refrigerant flow path 310 of the first converging portion 612.

According to the configuration shown in FIG. 28, a pressure loss in the connection portion 630 can be effectively reduced, and the refrigerant can flow more uniformly through the second branch portion 621 and the second converging portion 622.

<Sixth Configuration Example>

FIG. 29 is a plan view showing a sixth configuration example of the refrigerant layer 300 of the heat exchange plate 100.

As shown in FIG. 29, the connection portion 630 may be disposed between the midpoint C of the refrigerant layer 300 according to the predetermined direction and the second end portion 502. The midpoint C may be a point bisecting a width of the refrigerant layer 300 in the predetermined direction. However, an arrangement of the connection portion 630 is not limited thereto. For example, when the width of the refrigerant layer 300 in the predetermined direction is divided into four equal portions, the connection portion 630 may be disposed closer to the second end portion 502 than a point closest to the second end portion 502 side. Alternatively, when the width of the refrigerant layer 300 in the predetermined direction is divided into eight equal portions, the connection portion 630 may be disposed closer to the second end portion 502 than a point closest to the second end portion 502 side. Alternatively, when the width of the refrigerant layer 300 in the predetermined direction is divided into 16 equal portions, the connection portion 630 may be disposed closer to the second end portion 502 than a point closest to the second end portion 502 side.

For example, as shown in FIG. 29, the connection portion 630 may be disposed between a first branch flow path 613A closest to the second end portion 502 side and a first branch flow path 613B that is second closest to the second end portion 502 side. In addition, the connection portion 630 may be disposed between a second branch flow path 623A closest to the second end portion 502 side and a second branch flow path 623B that is second closest to the second end portion 502 side.

According to a configuration shown in FIG. 29, it is possible to prevent the refrigerant from being biased to the first branch flow path 613A that is closest to the second end portion 502. In addition, it is possible to prevent the refrigerant from being biased to the second branch flow path 623A closest to the second end portion 502. Accordingly, it is possible to further uniformize the refrigerant flowing through the entire refrigerant flow path 310.

The configuration shown in FIG. 28 may be combined with the configuration shown in FIG. 29. That is, the cross-sectional area S2 of the connection portion 630 shown in FIG. 29 may be larger than the cross-sectional area S1 of the refrigerant flow path 310 of the first converging portion 612.

<Seventh Configuration Example>

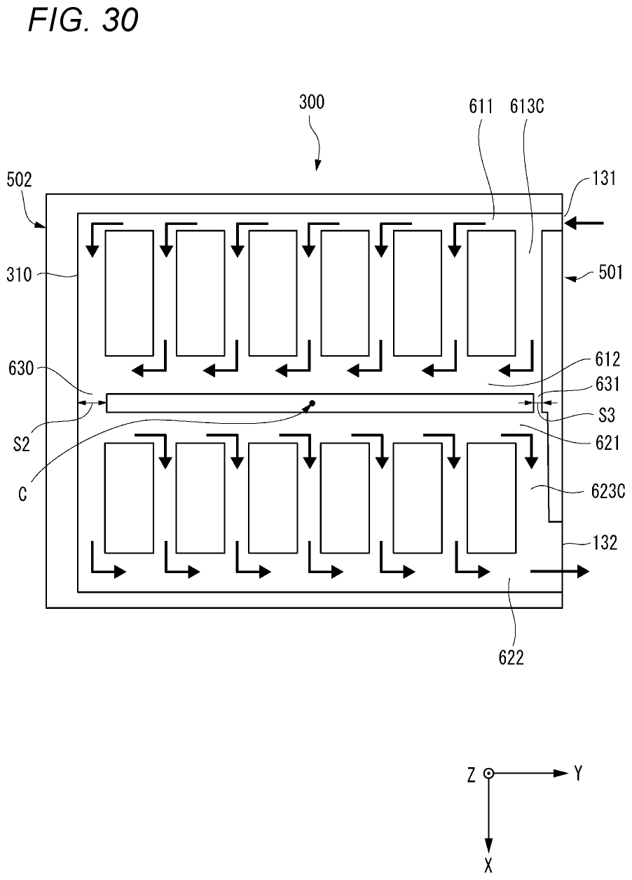

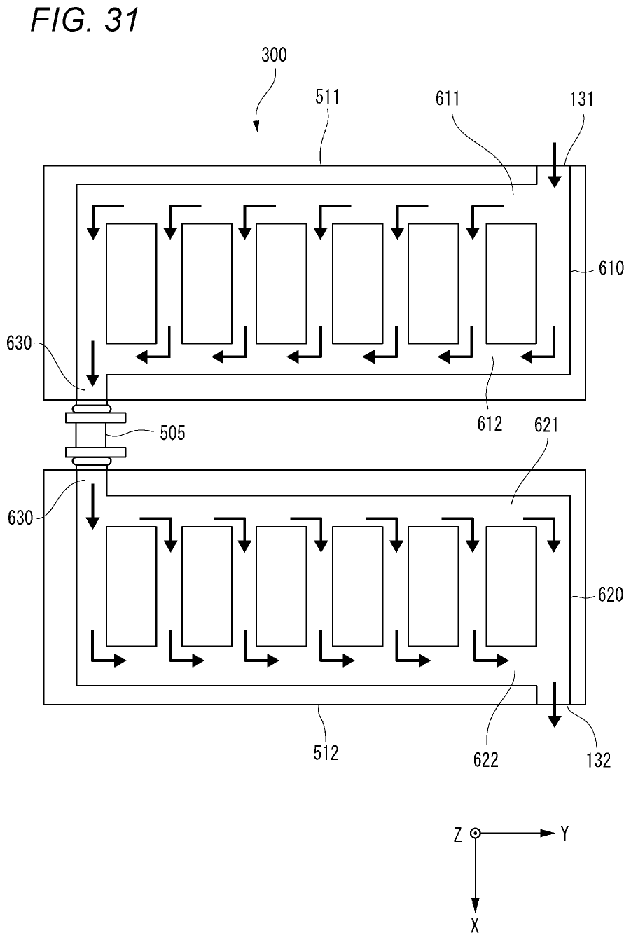

FIG. 30 is a plan view showing a seventh configuration example of the refrigerant layer 300 of the heat exchange plate 100.

As shown in FIG. 30, the refrigerant layer 300 may further include a bypass portion 631 that is disposed closer to the first end portion 501 than the midpoint C of the refrigerant layer 300 according to the predetermined direction and that connects the first converging portion 612 and the second branch portion 621. For example, the bypass portion 631 may be disposed so as to connect a first branch flow path 613C closest to the first end portion 501 side and a second branch flow path 623C closest to the first end portion 501 side. The cross-sectional area S2 of the refrigerant flow path 310 of the connection portion 630 may be wider than a cross-sectional area S3 of the refrigerant flow path 310 of the bypass portion 631. The connection portion 630 may be replaced with a first connection portion, and the bypass portion 631 may be replaced with a second connection portion.

According to the configuration shown in FIG. 30, a flow of the refrigerant in the first branch flow path 613 close to the first end portion 501 can be promoted. In addition, even when the refrigerant is dry out in the second branch flow path 623 close to the first end portion 501, the refrigerant having a large liquid phase is supplied from the first branch flow path 613 via the bypass portion 631, and thus it is possible to further uniformize a cooling capacity in the refrigerant flow path 310.

<Eighth Configuration Example>

FIG. 31 is a plan view showing an eighth configuration example of the refrigerant layer 300 of the heat exchange plate 100.

As shown in FIG. 31, the heat exchange plate 100 may include at least a first heat exchange plate 511 including the first refrigerant flow path 610 and a second heat exchange plate 512 including at least the second refrigerant flow path 620. A part of the connection portion 630 may include a pipe 505 that connects the first heat exchange plate 511 and the second heat exchange plate 512.

According to a configuration shown in FIG. 31, the large heat exchange plate 100 can be formed by respectively manufacturing the first heat exchange plate 511 and the second heat exchange plate 512, and connecting the first heat exchange plate 511 and the second heat exchange plate 512 by the pipe 505.

As shown in FIG. 31, the refrigerant input portion 131 of the first heat exchange plate 511 may be disposed at a position diagonally opposite to the connection portion 630. The refrigerant output portion 132 of the second heat exchange plate 512 may be disposed at a position diagonally opposite to the connection portion 630. Accordingly, a structure of the refrigerant flow path 310 of the first heat exchange plate 511 and a structure of the refrigerant flow path 310 of the second heat exchange plate 512 have a mirror-image relationship. Accordingly, for example, the first refrigerant flow path 610 of the first heat exchange plate 511 and the second refrigerant flow path 620 of the second heat exchange plate 512 can be manufactured by a common mold.

<Ninth Configuration Example>

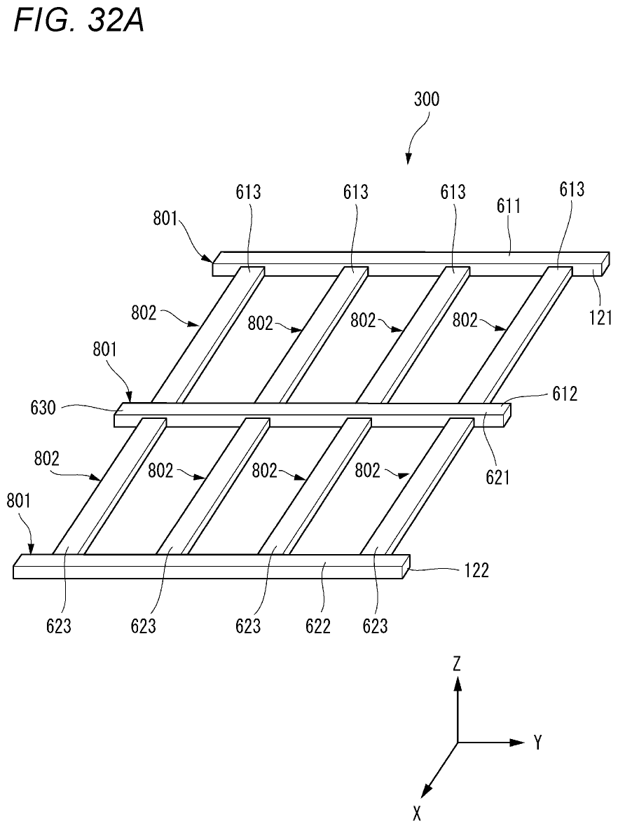

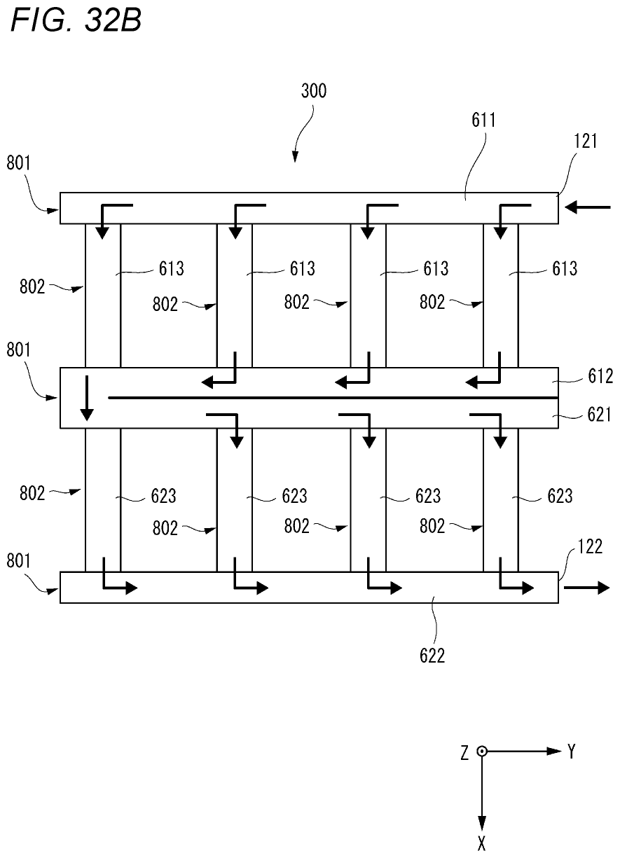

FIG. 32A is a perspective view showing a ninth configuration example of the refrigerant layer 300 of the heat exchange plate 100. FIG. 32B is a plan view showing the ninth configuration example of the refrigerant layer 300 of the heat exchange plate 100. At least a part of the first branch portion 611, the first converging portion 612, the plurality of first branch flow paths 613, the second branch portion 621, the second converging portion 622, and the plurality of second branch flow paths 623 in the heat exchange plate 100 may include a pipe. For example, the first branch portion 611, the first converging portion 612, the second branch portion 621, and the second converging portion 622 may be formed using a header pipe 801. The plurality of first branch flow paths 613 and the plurality of second branch flow paths 623 may be formed using multi-hole pipes 802 in each of which a plurality of holes penetrate in a longitudinal direction in the pipe.

In this way, by manufacturing the refrigerant flow path 310 of the heat exchange plate 100 using the general header pipe 801 and the multi-hole pipes 802, it is possible to reduce the cost.

<Modification>

The first configuration example to the ninth configuration example described above can be appropriately combined. For example, the third configuration example may be combined with any one of the fourth configuration example to the seventh configuration example. For example, the fourth configuration example may be combined with the seventh configuration example. The fifth configuration example may be combined with the sixth configuration example or the seventh configuration example. The sixth configuration example may be combined with the seventh configuration example.

At least a part of the first configuration example to the eighth configuration example may be formed by at least one of the header pipe 801 and the multi-hole pipe 802 shown in the ninth configuration example.

Although embodiments have been described above with reference to the accompanying drawings, the present disclosure is not limited thereto. It is obvious to those skilled in the art that various changes, modifications, replacements, additions, deletions, and equivalents can be conceived within the scope described in the claims, and it is understood that these also belong to the technical scope of the present disclosure. In addition, components in the embodiments described above may be combined freely in a range without deviating from the spirit of the invention.

(A-1)

A vehicle including:
a vehicle body;
a first wheel and a second wheel coupled to the vehicle body;
a battery module group disposed along a predetermined plane in the vehicle body and including a plurality of battery modules;
a heat exchange plate disposed along the predetermined plane in the vehicle body; and
an electric motor configured to drive at least the first wheel using electric power supplied from the battery module group, in which
the heat exchange plate includes
a first planar member disposed along the predetermined plane,
a second planar member disposed along the predetermined plane, and
a third planar member disposed along the predetermined plane,
at least a part of the second planar member is disposed between the first planar member and the third planar member,
the battery module group is disposed at a position opposite to the second planar member with reference to the first planar member,
the heat exchange plate further includes
a coolant layer configured to allow a coolant to circulate between the first planar member and the second planar member,
a refrigerant layer configured to allow a refrigerant to circulate between the second planar member and the third planar member, and
a wall portion constituting at least a part of a flow path of the coolant in the coolant layer, and
at least a part of the wall portion of the coolant layer includes a first protruding portion protruding from the first planar member toward the second planar member and a second protruding portion protruding from the second planar member toward the first planar member.

(A-2)

The vehicle according to A-1, in which
at least a part of the wall portion of the coolant layer is disposed along a predetermined direction along the predetermined plane in the coolant layer,
the refrigerant layer of the heat exchange plate includes a flow path of the refrigerant, and
the at least a part of the wall portion and at least a part of the flow path of the refrigerant intersect with each other as viewed from a normal direction of the predetermined plane.

(A-3)

The vehicle according to A-1, in which
the flow path of the refrigerant in the refrigerant layer is formed in a shape of the third planar member.

(A-4)

The vehicle according to A-2 or A-3, in which
the predetermined direction of the wall portion corresponds to a traveling direction in which the vehicle body is travelable by the first wheel and the second wheel.

(A-5)

The vehicle according to any one of A-2 to A-4, in which
the first protruding portion is disposed in a manner of corresponding to an intersection at which the at least a part of the wall portion of the coolant and the at least a part of the flow path of the refrigerant intersect with each other.

(A-6)

The vehicle according to any one of A-2 to A-4, in which
the flow path of the refrigerant includes at least a first refrigerant flow path and a second refrigerant flow path,
the at least a part of the wall portion and at least a part of the first refrigerant flow path intersect at a first intersection as viewed from the normal direction of the predetermined plane,
the at least a part of the wall portion and at least a part of the second refrigerant flow path intersect at a second intersection when viewed from the normal direction of the predetermined plane, and
the first protruding portion is disposed between the first intersection and the second intersection.

(A-7)

The vehicle according to any one of A-1 to A-6, in which
the first protruding portion is disposed at a position that does not correspond to one of the plurality of battery modules.

(A-8)

The vehicle according to any one of A-1 to A-7, in which
the wall portion includes a first wall surface, a second wall surface opposite to the first wall surface, and an end surface connecting the first wall surface and the second wall surface, and
the coolant advances along the first wall surface, then along the end surface, and then along the second wall surface in the coolant layer.

(A-9)

The vehicle according to any one of A-1 to A-8, in which
the heat exchange plate performs heat exchange at least between the battery module group and the coolant via the first planar member.

(A-10)

The vehicle according to any one of A-1 to A-9, further including:
in the vehicle body, a housing that accommodates the battery module group and the heat exchange plate.

(A-11)

A heat exchange plate installable on a vehicle,
the vehicle including
a vehicle body,
a first wheel and a second wheel coupled to the vehicle body,
a battery module group disposed along a predetermined plane in the vehicle body and including a plurality of battery modules, and
an electric motor configured to drive at least the first wheel using electric power supplied from the battery module group,
the heat exchange plate being disposed along the predetermined plane in the vehicle body and including:
a first planar member disposed along the predetermined plane;
a second planar member disposed along the predetermined plane;
a third planar member disposed along the predetermined plane;
a coolant layer configured to allow a coolant to circulate between the first planar member and the second planar member;
a refrigerant layer configured to allow a refrigerant to circulate between the second planar member and the third planar member; and
a wall portion constituting at least a part of a flow path of the coolant in the coolant layer, in which
at least a part of the second planar member is disposed between the first planar member and the third planar member, and
at least a part of the wall portion of the coolant layer includes a first protruding portion protruding from the first planar member toward the second planar member and a second protruding portion protruding from the second planar member toward the first planar member.

(A-12)

The heat exchange plate according to A-11, in which
at least a part of the wall portion of the coolant layer is disposed along a predetermined direction along the predetermined plane in the coolant layer,
the refrigerant layer of the heat exchange plate includes a flow path of the refrigerant, and
the at least a part of the wall portion and the at least a part of the flow path of the refrigerant intersect with each other as viewed from a normal direction of the predetermined plane.

(A-13)

The heat exchange plate according to A-12, in which
the flow path of the refrigerant in the refrigerant layer is formed in a shape of the third planar member.

(A-14)

The heat exchange plate according to A-12 or A-13, in which
the predetermined direction of the wall portion is set in a manner of corresponding to a traveling direction in which the vehicle body is travelable by the first wheel and the second wheel.

(A-15)

The heat exchange plate according to any one of A-12 to A-14, in which
the first protruding portion is disposed in a manner of corresponding to an intersection at which the at least a part of the wall portion of the coolant and the at least a part of the flow path of the refrigerant intersect with each other.

(A-16)

The heat exchange plate according to any one of A-12 to A-14, in which
the flow path of the refrigerant includes at least a first refrigerant flow path and a second refrigerant flow path,
the at least a part of the wall portion and at least a part of the first refrigerant flow path intersect at a first intersection as viewed from the normal direction of the predetermined plane,
the at least a part of the wall portion and at least a part of the second refrigerant flow path intersect at a second intersection when viewed from the normal direction of the predetermined plane, and
the first protruding portion is disposed between the first intersection and the second intersection.

(A-17)

The heat exchange plate according to any one of A-11 to A-16, in which
the first protruding portion is disposed at a position that does not correspond to one of the plurality of battery modules.

(A-18)

The heat exchange plate according to any one of A-11 to A-17, in which
the wall portion includes a first wall surface, a second wall surface opposite to the first wall surface, and an end surface connecting the first wall surface and the second wall surface, and
the coolant advances along the first wall surface, then along the end surface, and then along the second wall surface in the coolant layer.

(A-19)

The heat exchange plate according to any one of A-11 to A-18, in which
the heat exchange plate is configured to perform heat exchange at least between the battery module group and the coolant via the first planar member.

(A-20)

The heat exchange plate according to any one of A-11 to A-19, in which
the heat exchange plate is accommodated in a housing together with the battery module group in the vehicle body.

(B-1)

A vehicle including:
a vehicle body;
a first wheel and a second wheel coupled to the vehicle body;
a battery cell group disposed along a predetermined plane in the vehicle body and including a plurality of battery cells;
a heat exchange plate disposed along the predetermined plane in the vehicle body;
an electric motor configured to drive at least the first wheel using electric power supplied from the battery cell group; and
a refrigerant circuit including at least a compressor and a condenser, in which
the heat exchange plate includes
a first surface disposed along the predetermined plane,
a second surface opposite to the first surface,
a coolant layer configured to allow a coolant to circulate between the first surface and the second surface, and
a refrigerant layer configured to allow a refrigerant to circulate between the first surface and the second surface,
the refrigerant layer includes a refrigerant input portion configured to allow the refrigerant to enter the refrigerant layer from the refrigerant circuit, and a refrigerant output portion configured to allow the refrigerant to exit from the refrigerant layer to the refrigerant circuit,
the first surface includes a first region that is a region in which the battery cell group is disposed, and a second region that is a region in which the battery cell group is not disposed,
a flow path of the refrigerant in the refrigerant layer is formed across the first region and the second region, and
the refrigerant output portion is disposed in the second region.

(B-2)

The vehicle according to B-1, in which
the refrigerant input portion is disposed in the second region at a position closer to the first region than the refrigerant output portion.

(B-3)

The vehicle according to B-1 or B-2, further including:
a coolant circuit including at least a pump, in which
the coolant layer includes a coolant input portion configured to allow the coolant to enter the coolant layer from the coolant circuit, and a coolant output portion configured to allow the coolant to exit from the coolant layer to the coolant circuit, and
at least one of the coolant input portion and the coolant output portion is disposed in the second region.

(B-4)

The vehicle according to any one of B-1 to B-3, further including:
a heat conductive member disposed between the battery cell group and the heat exchange plate in at least a part of the first region of the heat exchange plate, the heat conductive member having a first heat conductivity; and
a heat insulating member having a second heat conductivity in at least a part of the second region of the heat exchange plate, in which
the first heat conductivity is greater than the second heat conductivity.

(B-5)

The vehicle according to any one of B-1 to B-4, further including:
in the second region of the heat exchange plate, a condensed water recovery portion configured to recover condensed water generated in a portion including the second region of the heat exchange plate.

(B-6)

The vehicle according to any one of B-1 to B-5, in which
the first surface further includes a third region, which is a region in which the battery cell group is not disposed, on a side opposite to the second region across the first region, and
the flow path of the refrigerant in the refrigerant layer is formed across the first region, the second region, and the third region.

(B-7)

The vehicle according to any one of B-3 to B-6, in which
the flow path of the refrigerant in the refrigerant layer includes
a first refrigerant flow path connected to the refrigerant input portion,
a plurality of branch refrigerant flow paths branching from the first refrigerant flow path,
a second refrigerant flow path in which the plurality of branch refrigerant flow paths converge, and
a third refrigerant flow path connected to the refrigerant output portion from the second refrigerant flow path, and
at least a part of the third refrigerant flow path is in the second region.

(B-8)

The vehicle according to B-7, in which
the flow path of the refrigerant in the refrigerant layer further includes a throttle portion configured to throttle a flow rate of the refrigerant between the second refrigerant flow path and the third refrigerant flow path.

(B-9)

The vehicle according to claim 8, in which
a pressure of the refrigerant in the third refrigerant flow path is lower than a pressure of the refrigerant in the second refrigerant flow path.

(B-10)

The vehicle according to any one of B-7 to B-9, in which
a flow path of the coolant in the coolant layer includes
a first coolant flow path connected to the coolant input portion and disposed along a predetermined direction, and
a second coolant flow path connected to the first coolant flow path, disposed along the predetermined direction, and connected to the coolant output portion,
at least a part of the first coolant flow path intersects with at least a part of the branch refrigerant flow paths when viewed from a normal direction of the predetermined plane in the second region, and
at least a part of the second coolant flow path intersects with at least a part of the branch refrigerant flow paths when viewed from the normal direction of the predetermined plane in the second region.

(B-11)

A heat exchange plate installable on a vehicle,
the vehicle including
a vehicle body,
a first wheel and a second wheel coupled to the vehicle body,
a battery cell group disposed along a predetermined plane in the vehicle body and including a plurality of battery cells,
an electric motor configured to drive at least the first wheel using electric power supplied from the battery cell group, and
a refrigerant circuit including at least a compressor and a condenser, the heat exchange plate including:
a first surface disposed along the predetermined plane;
a second surface opposite to the first surface;
a coolant layer configured to allow a coolant to circulate between the first surface and the second surface; and
a refrigerant layer configured to allow a refrigerant to circulate between the first surface and the second surface, in which
the refrigerant layer includes a refrigerant input portion configured to allow the refrigerant to enter the refrigerant layer from the refrigerant circuit, and a refrigerant output portion configured to allow the refrigerant to exit from the refrigerant layer to the refrigerant circuit,
the first surface includes a first region that is a region in which the battery cell group is disposed, and a second region that is a region in which the battery cell group is not disposed,
a flow path of the refrigerant in the refrigerant layer is formed across the first region and the second region, and
the refrigerant output portion is disposed in the second region.

(B-12)

The heat exchange plate according to B-11, in which
the refrigerant input portion is disposed in the second region at a position closer to the first region than the refrigerant output portion.

(B-13)

The heat exchange plate according to B-11 or B-12, in which
the vehicle includes a coolant circuit including at least a pump,
the coolant layer includes a coolant input portion configured to allow the coolant to enter the coolant layer from the coolant circuit, and a coolant output portion configured to allow the coolant to exit from the coolant layer to the coolant circuit, and
at least one of the coolant input portion and the coolant output portion is disposed in the second region.

(B-14)

The heat exchange plate according to any one of B-11 to B-13, further including:
a heat conductive member disposed between the battery cell group and the heat exchange plate in at least a part of the first region, the heat conductive member having a first heat conductivity; and
a heat insulating member having a second heat conductivity in at least a part of the second region, in which
the first heat conductivity is greater than the second heat conductivity.

(B-15)

The heat exchange plate according to any one of B-11 to B-14, further including:
in the second region, a condensed water recovery portion configured to recover condensed water generated in a portion including the second region of the heat exchange plate.

(B-16)

The heat exchange plate according to any one of B-11 to B-15, in which
the first surface further includes a third region, which is a region in which the battery cell group is not disposed, on a side opposite to the second region across the first region, and
the flow path of the refrigerant in the refrigerant layer is formed across the first region, the second region, and the third region.

(B-17)

The heat exchange plate according to any one of B-13 to B-16, in which
the flow path of the refrigerant in the refrigerant layer includes
a first refrigerant flow path connected to the refrigerant input portion,
a plurality of branch refrigerant flow paths branching from the first refrigerant flow path,
a second refrigerant flow path in which the plurality of branch refrigerant flow paths converge, and
a third refrigerant flow path connected to the refrigerant output portion from the second refrigerant flow path, and
at least a part of the third refrigerant flow path is in the second region.

(B-18)

The heat exchange plate according to B-17, in which
the flow path of the refrigerant in the refrigerant layer further includes a throttle portion configured to throttle a flow rate of the refrigerant between the second refrigerant flow path and the third refrigerant flow path.

(B-19)

The heat exchange plate according to B-18, in which
a pressure of the refrigerant in the third refrigerant flow path is lower than a pressure of the refrigerant in the second refrigerant flow path.

(B-20)

The heat exchange plate according to any one of B-17 to B-19, in which
a flow path of the coolant in the coolant layer includes
a first coolant flow path connected to the coolant input portion and disposed along a predetermined direction, and
a second coolant flow path connected to the first coolant flow path, disposed along the predetermined direction, and connected to the coolant output portion,
at least a part of the first coolant flow path intersects with at least a part of the branch refrigerant flow paths when viewed from a normal direction of the predetermined plane in the second region, and
at least a part of the second coolant flow path intersects with at least a part of the branch refrigerant flow paths when viewed from the normal direction of the predetermined plane in the second region.

The present application is based on a Japan patent application (Japanese Patent Application No. 2021-025622) filed on Feb. 19, 2021, and the contents thereof are incorporated herein by reference. Further, the present application is based on a Japanese patent application (Japanese Patent Application No. 2021-038370) filed on Mar. 10, 2021, and the contents thereof are incorporated herein by reference. The present application is based on a Japanese patent application (Japanese Patent Application No. 2021-038371) filed on Mar. 10, 2021, and the contents thereof are incorporated herein by reference.

### INDUSTRIAL APPLICABILITY

The technique of the present disclosure is useful for adjusting a temperature of an in-vehicle battery.

What is claimed is:

1. A heat exchange plate installable on a vehicle movable in a predetermined direction using a first wheel and a second wheel,
the vehicle including
a vehicle body,
the first wheel and the second wheel coupled to the vehicle body,
a battery cell group disposed along a predetermined plane in the vehicle body and including a plurality of battery cells,
a heat exchange plate disposed along the predetermined plane in the vehicle body,
an electric motor configured to drive at least the first wheel using electric power supplied from the battery cell group, and
a refrigerant circuit including at least a compressor and a condenser,
the heat exchange plate comprising:
a first surface disposed along the predetermined plane;
a second surface opposite to the first surface;
a coolant layer configured to allow a coolant to circulate between the first surface and the second surface;
a refrigerant layer configured to allow a refrigerant to circulate between the first surface and the second surface;
a first end portion in the predetermined direction; and
a second end portion opposite to the first end portion in the predetermined direction, wherein
the refrigerant layer includes
a refrigerant input portion disposed at the first end portion and configured to enter the refrigerant layer from the refrigerant circuit,
a refrigerant output portion disposed at the first end portion and configured to exit from the refrigerant layer to the refrigerant circuit,
a first refrigerant flow path connected to the refrigerant input portion and disposed along the predetermined direction,
a second refrigerant flow path connected to the refrigerant output portion and disposed along the predetermined direction, and
a connection portion connecting the first refrigerant flow path and the second refrigerant flow path,
the first refrigerant flow path includes a first branch portion, a first converging portion, and a plurality of first branch flow paths connecting the first branch portion and the first converging portion,
the second refrigerant flow path includes a second branch portion, a second converging portion, and a plurality of second branch flow paths connecting the second branch portion and the second converging portion,
the refrigerant is movable through the refrigerant input portion, the first branch portion, the first branch flow paths, the first converging portion, the connection portion, the second branch portion, the second branch flow paths, the second converging portion, and the refrigerant output portion in this order, and
the connection portion is disposed closer to the second end portion than a midpoint of the refrigerant layer in the predetermined direction.

2. The heat exchange plate according to claim 1, wherein,
at least a part of the plurality of first branch flow paths are disposed along a direction intersecting the predetermined direction when viewed from a normal direction of the predetermined plane, and
at least a part of the plurality of second branch flow paths are disposed along a direction intersecting the predetermined direction when viewed from the normal direction of the predetermined plane.

3. The heat exchange plate according to claim 1, further comprising:
a thermal expansion valve disposed between the refrigerant input portion and the refrigerant circuit, and between the refrigerant output portion and the refrigerant circuit.

4. The heat exchange plate according to claim 1, wherein
the vehicle includes a coolant circuit including at least a pump,
the coolant layer includes
a coolant input portion configured to enter the coolant layer from the coolant circuit,
a coolant output portion configured to exit from the coolant layer to the coolant circuit,
a first coolant flow path connected to the coolant input portion or the coolant output portion and disposed along the predetermined direction, at least a part of the first coolant flow path being disposed in a manner of overlapping with the first refrigerant flow path, and
a second coolant flow path connected to the coolant output portion or the coolant input portion, connected to the first coolant flow path, and disposed along the predetermined direction, at least a part of the second coolant flow path being disposed in a manner of overlapping with the second refrigerant flow path,
a first refrigerant orientation in the predetermined direction of the refrigerant moving in the first refrigerant flow path is opposite to a first coolant orientation in the predetermined direction of the coolant moving in the first coolant flow path, and
a second refrigerant orientation in the predetermined direction of the refrigerant moving in the second refrigerant flow path is opposite to a second coolant orientation in the predetermined direction of the coolant moving in the second coolant flow path.

5. The heat exchange plate according to claim 1, wherein
the vehicle includes a coolant circuit including at least a pump,
the coolant layer includes
a coolant input portion configured to enter the coolant layer from the coolant circuit,
a coolant output portion configured to exit from the coolant layer to the coolant circuit,
a first coolant flow path connected to the coolant input portion or the coolant output portion and disposed along the predetermined direction, at least a part of the first coolant flow path being disposed in a manner of overlapping with the first refrigerant flow path, and
a second coolant flow path connected to the coolant output portion or the coolant input portion, connected to the first coolant flow path, and disposed along the predetermined direction, at least a part of the second coolant flow path being disposed in a manner of overlapping with the second refrigerant flow path,
a first refrigerant orientation in the predetermined direction of the refrigerant moving in the first refrigerant flow path is the same as a first coolant orientation in the predetermined direction of the coolant moving in the first coolant flow path, and
a second refrigerant orientation in the predetermined direction of the refrigerant moving in the second refrigerant flow path is the same as a second coolant orientation in the predetermined direction of the coolant moving in the second coolant flow path.

6. The heat exchange plate according to claim 4, wherein
the coolant input portion and the coolant output portion are disposed at the first end portion.

7. The heat exchange plate according to claim 1, wherein
the first refrigerant flow path includes a third branch portion,
the third branch portion is connected to the refrigerant input portion, the first branch portion, and the first converging portion, and
the refrigerant input to the refrigerant input portion is capable of branching into a flow to the first branch portion and a flow to the first converging portion at the third branch portion.

8. The heat exchange plate according to claim 1, wherein
the second refrigerant flow path includes a fourth branch portion,
the fourth branch portion is connected to the connection portion, the second branch portion, and the second converging portion, and
the refrigerant passing through the connection portion is capable of branching into a flow to the second branch portion and a flow to the second converging portion at the fourth branch portion.

9. The heat exchange plate according to claim 1, wherein,
a cross-sectional area of a refrigerant flow path of the connection portion is larger than a cross-sectional area of a refrigerant flow path of the first converging portion.

10. The heat exchange plate according to claim 1, wherein
the connection portion is disposed between the midpoint of the refrigerant layer in the predetermined direction and the second end portion.

11. The heat exchange plate according to claim 1, wherein
the connection portion serves as a first connection portion, and
the heat exchange plate further includes a second connection portion disposed closer to the first end portion than the midpoint of the refrigerant layer in the predetermined direction and connecting the first converging portion and the second branch portion.

12. The heat exchange plate according to claim 11, wherein
a cross-sectional area of a refrigerant flow path of the first connection portion is larger than a cross-sectional area of a refrigerant flow path of the second connection portion.

13. The heat exchange plate according to claim 1, wherein
the heat exchange plate is constructed with a first heat exchange plate including at least the first refrigerant flow path and a second heat exchange plate including at least the second refrigerant flow path, and
a part of the connection portion includes a pipe that connects the first heat exchange plate and the second heat exchange plate.

14. The heat exchange plate according to claim 1, wherein
at least a part of the first branch portion, the first converging portion, the plurality of first branch flow paths, the second branch portion, the second converging portion, and the plurality of second branch flow paths include a pipe.

15. The heat exchange plate according to claim 1, further comprising:
a coolant input portion configured to allow a coolant to be input to the coolant layer; and
a coolant output portion configured to allow the coolant to be output from the coolant layer, wherein
the coolant layer includes a first coolant flow path corresponding to the first refrigerant flow path and disposed along the predetermined direction, and a second coolant flow path corresponding to the second refrigerant flow path and disposed along the predetermined direction,
the coolant is movable through the coolant input portion, the first coolant flow path, the second coolant flow path, and the coolant output portion,
an orientation of movement in the predetermined direction of the refrigerant moving in the first refrigerant flow path is opposite to an orientation of movement in the predetermined direction of the coolant moving in the first coolant flow path, and
an orientation of movement in the predetermined direction of the refrigerant moving in the second refrigerant flow path is opposite to an orientation of movement in the predetermined direction of the coolant moving in the second coolant flow path.

16. The heat exchange plate according to claim 1, further comprising:
a coolant input portion configured to allow a coolant to be input to the coolant layer; and
a coolant output portion configured to allow the coolant to be output from the coolant layer, wherein
the coolant layer includes a first coolant flow path corresponding to the first refrigerant flow path and disposed along the predetermined direction, and a second coolant flow path corresponding to the second refrigerant flow path and disposed along the predetermined direction,
the coolant is movable through the coolant input portion, the first coolant flow path, the second coolant flow path, and the coolant output portion,
an orientation of movement in the predetermined direction of the refrigerant moving in the first refrigerant flow path is the same as an orientation of movement in the predetermined direction of the coolant moving in the first coolant flow path, and
an orientation of movement in the predetermined direction of the refrigerant moving in the second refrigerant flow path is the same as an orientation of movement in the predetermined direction of the coolant moving in the second coolant flow path.

17. A vehicle movable in a predetermined direction using a first wheel and a second wheel, the vehicle comprising:
a vehicle body;
the first wheel and the second wheel coupled to the vehicle body;
a battery cell group disposed along a predetermined plane in the vehicle body and including a plurality of battery cells;
a heat exchange plate disposed along the predetermined plane in the vehicle body;
an electric motor configured to drive at least the first wheel using electric power supplied from the battery cell group; and
a refrigerant circuit including at least a compressor and a condenser, wherein
the heat exchange plate includes
a first surface disposed along the predetermined plane,
a second surface opposite to the first surface,
a coolant layer configured to allow a coolant to circulate between the first surface and the second surface,
a refrigerant layer configured to allow a refrigerant to circulate between the first surface and the second surface,
a first end portion in the predetermined direction, and
a second end portion opposite to the first end portion in the predetermined direction,
the refrigerant layer includes
a refrigerant input portion disposed at the first end portion and configured to allow the refrigerant to enter the refrigerant layer from the refrigerant circuit,
a refrigerant output portion disposed at the first end portion and configured to allow the refrigerant to exit from the refrigerant layer to the refrigerant circuit,
a first refrigerant flow path connected to the refrigerant input portion and disposed along the predetermined direction,
a second refrigerant flow path connected to the refrigerant output portion and disposed along the predetermined direction, and
a connection portion connecting the first refrigerant flow path and the second refrigerant flow path,
the first refrigerant flow path includes a first branch portion, a first converging portion, and a plurality of first branch flow paths connecting the first branch portion and the first converging portion,
the second refrigerant flow path includes a second branch portion, a second converging portion, and a plurality of second branch flow paths connecting the second branch portion and the second converging portion,
the refrigerant is movable through the refrigerant input portion, the first branch portion, the first branch flow paths, the first converging portion, the connection portion, the second branch portion, the second branch flow paths, the second converging portion, and the refrigerant output portion in this order, and
the connection portion is disposed closer to the second end portion than a midpoint of the refrigerant layer in the predetermined direction.

18. The vehicle according to claim 17, wherein,
at least a part of the plurality of first branch flow paths are disposed along a direction intersecting the predetermined direction when viewed from a normal direction of the predetermined plane, and
at least a part of the plurality of second branch flow paths are disposed along a direction intersecting the predetermined direction when viewed from the normal direction of the predetermined plane.

19. The vehicle according to claim 17, further comprising:
a thermal expansion valve disposed between the refrigerant input portion and the refrigerant circuit, and between the refrigerant output portion and the refrigerant circuit.

20. The vehicle according to claim 17, further comprising:
a coolant circuit including at least a pump, wherein
the coolant layer includes
a coolant input portion configured to enter the coolant layer from the coolant circuit,
a coolant output portion configured to exit from the coolant layer to the coolant circuit,
a first coolant flow path connected to the coolant input portion or the coolant output portion and disposed along the predetermined direction, at least a part of the first coolant flow path being disposed in a manner of overlapping with the first refrigerant flow path, and
a second coolant flow path connected to the coolant output portion or the coolant input portion, connected to the first coolant flow path, and disposed along the predetermined direction, at least a part of the second coolant flow path being disposed in a manner of overlapping with the second refrigerant flow path,
a first refrigerant orientation in the predetermined direction of the refrigerant moving in the first refrigerant flow path is opposite to a first coolant orientation in the predetermined direction of the coolant moving in the first coolant flow path, and
a second refrigerant orientation in the predetermined direction of the refrigerant moving in the second refrigerant flow path is opposite to a second coolant orientation in the predetermined direction of the coolant moving in the second coolant flow path.
